(19) United States
(12) Patent Application Publication
(10) Pub. No.: US 2025/0086088 A1
(43) Pub. Date: Mar. 13, 2025

(54) SYSTEM AND DEVICE HAVING A PROGRAM EXECUTED THEREON TO, IN SOME EMBODIMENTS VIA NUANCED SIMULATION, ADAPTIVELY ANSWER CONTEXTUALIZED, SITUATION-SPECIFIC, GENERALIZED, AND/OR CONTEXT-SPECIFIC QUERIES, AND METHOD THEREOF

(71) Applicant: Daniel Joseph Olsher, Concord, CA (US)

(72) Inventor: Daniel Joseph Olsher, Concord, CA (US)

(21) Appl. No.: 18/611,684

(22) Filed: Mar. 20, 2024

Related U.S. Application Data
(63) Continuation-in-part of application No. 15/573,308, filed on Nov. 10, 2017.
(60) Provisional application No. 63/453,209, filed on Mar. 20, 2023.

(51) Int. Cl. G06F 11/34

(52) U.S. Cl. CPC G06F 11/3457; G06F 11/3428

(57) ABSTRACT

Many conventional search engines and programs allow users to find answers to questions. However, these answers are not tailored for the user, the context, and/or the broader situation or scenario in which the queries are grounded, as these tools cannot think nor understand, cannot simulate, do not offer genuine intelligence, and cannot perform advanced cognitive processing. They are therefore only able to return generalized answers. There is a need for a system and/or device that executes a program and/or mobile application that accurately answers any type of general query input by a user, especially when the query requires consideration of complex knowledge, causality, psychology, and/or specific user, context-driven, scenario-driven, and/or situational circumstances. In some embodiments, this may be performed via nuanced simulation, which method is in many cases ideal for achieving the foregoing.

### CROSS-REFERENCE TO RELATED APPLICATIONS

This application claims the benefit of U.S. Provisional Application No. 63/453,209, filed Mar. 20, 2023, and is also a continuation-in-part of U.S. application Ser. No. 15/573,308 filed on Nov. 10, 2017 and entitled “Systems and Methods for a Universal Task Independent Simulation and Control Platform for Generating Controlled Actions Using Nuanced Artificial Intelligence,” which claims priority from International Application No. PCT/US16/31908, filed on May 11, 2016 and entitled Systems and Methods for a Universal Task Independent Simulation and Control Platform for Generating Controlled Actions Using Nuanced Artificial Intelligence,” which claimed priority from U.S. Provisional Patent Application No. 62/159,800, filed May 11, 2015 and entitled “System and Method for Nuanced Artificial Intelligence Reasoning, Decision-making, and Recommendation,” the entire disclosures of which are incorporated herein by reference.

### BACKGROUND

### 1. Field

The present general inventive concept relates generally to a system and device having a program executed thereon to, in some embodiments via nuanced simulation, adaptively answer contextualized, situation-specific, generalized, and/or context-specific queries, and method thereof.

### 2. Description of the Related Art

Many conventional search engines and programs allow users to input queries to find answers to questions. However, these answers are not tailored for the user, the context, and/or the broader situation or scenario in which the queries are grounded, as the conventional search engines do not perform any type of actual “thinking,” and therefore only return generalized answers. For example, conventional search engines allow a user to input a query such as “who was the first president of the USA?”, as the answer “George Washington” would be returned. However, if the user attempted to input the query “who should I vote for?”, the best thing that the search engine may do is return a plurality of potential candidates with their specific political viewpoints. Such tools cannot think nor understand, cannot simulate, do not offer genuine intelligence, and cannot perform advanced cognitive processing. They are therefore only able to return generalized answers. In other words, conventional tools cannot answer user-specific, contextualized, situation-aware, and/or scenario-aware, or generalized questions.

As such, there is a need for a system and/or device that executes a program and/or mobile application that accurately answers any type of query input by a user, even when the query is generalized, and especially when the query requires consideration regarding specific user, context-driven, scenario-driven, and/or situational circumstances.

There is also a need for the above technology to be able to be delivered in the form of an application, as a component of a larger system, as an application programming interface (API), and in other forms.

### SUMMARY

The present general inventive concept relates generally to a system and device having a program executed thereon to, in some embodiments via nuanced simulation, adaptively answer contextualized, situation-specific, generalized, and/or context-specific queries, and method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may in some embodiments be achieved by providing a system having a program executed thereon to answer a query, the system including a server to at least one of store and access first information, to at least one of store and access second information, and to at least one of store and access third information, and a device, including an input unit to allow the user to input the query, a communication unit to communicate with the server to access the first information, the second information, and the third information, a processor to output an answer to the query based on the first information and the third information with regard to a context of the second information, and a display unit to display the answer to the query.

The first information may in some embodiments include information related to the user, scenario, situation, and/or context, the second information may include information defining the query, and the third information may include domain information related to the query.

The information related to the user may in some embodiments include at least one of general information about the user, information about the user's goals, needs, wants, and/or concerns, idiosyncratic information about the user, information that is surmised about the user, information that is deduced about the user, information that is associated with the user, information that is tangentially related to the user, information regarding a personality of the user, information about the user's medical history, information about the user's preferences, information regarding the user's work history, and information about the user's personal history.

The information related to the scenario, situation, and/or context may in some embodiments include at least one of general information about the scenario, situation, and/or context, idiosyncratic information about the scenario, situation, and/or context, information that is surmised about the scenario, situation, and/or context, information that is deduced about the scenario, situation, and/or context, information that is associated with the scenario, situation, and/or context, information that is tangentially related to the scenario, situation, and/or context, information that is directly related to the scenario, situation, and/or context, information regarding the history of the scenario, situation, and/or context, information about general preferences, information regarding the causal components of, contents of, participants in, and/or influences on the scenario, situation, and/or context, and information that explains and/or describes the scenario, situation, and/or context.

The processor may in some embodiments output the answer to the query by executing at least one simulation including the first information and the third information with regard to the context of the second information.

The answer to the query may in some embodiments be based on a best score or rank assigned to one of the at least one simulation, as a result of the at least one simulation simulating various combinations of the first information, the second information, and the third simulation.

The combination of the first information, the second information, and the third simulation that produces the best scored or ranked simulation may in some embodiments include the answer to the query that is best tailored to the user, scenario, situation, and/or context.

The information defining the query may in some embodiments include information that parses or interprets the query to allow the processor to understand and utilize the query during the at least one simulation.

The domain information related to the query may in some embodiments include at least one of information that is semantically relatable to the query and information that has a tangential relationship with the query.

The foregoing and/or other features and utilities of the present general inventive concept may also be achieved by providing a device having a program executed thereon to provide an answer to a query, the device including an input unit to allow the user to input the query, a communication unit to communicate with outside sources of information to access a plurality of information, a processor to use the plurality of information to execute a plurality of simulations and to rank the plurality of simulations in order to determine which one of the plurality of simulations has a best rank, and a display unit to output the answer to the query as the information that produced the best ranked simulation.

The plurality of information may in some embodiments include first information including information related to the user, scenario, situation, and/or context, second information including information defining the query, and third information including domain information related to the query.

The foregoing and/or other features and utilities of the present general inventive concept may also be achieved by providing a method of answering generalized queries within a system including a device having a program executed thereon and a server communicating with the device, the method including receiving an input of a query in at least one of an input unit of the device and another input unit of the server, retrieving from at least one of the server and the Internet, first information related to a user, scenario, situation, and/or context, second information defining the query, and third information related to the query, executing a plurality of simulations within at least one of a processor of the device and another processor of the server, the plurality of simulations being executed by utilizing various combinations of the first information related to a user, scenario, situation, and/or context, the second information defining the query, and the third information related to the query, optionally ranking the plurality of executed simulations based on the most favorable outcome for the user and/or at least one utility function relative to the scenario, situation, user goals, and/or context, outputting the best ranked simulations, and optionally displaying information that outputs the best ranked simulations, or some set thereof, as an answer to the query. Determination of ‘best’ may optionally be achieved by full and/or partial reference to maximization, minimization, simulation, and/or other use of some arbitrary function, potential or actual state of the world, potential or actual state of affairs, potential or actual needs/goals, potential or actual situation, potential or actual simulation, potential or actual preference set, potential or actual counterfactual, potential or actual goal, potential or actual drive, potential or actual desire, potential or actual goal set, person. organization, customer, and/or entity.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

The drawings illustrate optional aspects of systems and system components that may optionally be relevant to various embodiments of the present general inventive concept.

FIGS. 1 and 2 illustrate schematic block diagrams of a system in accordance with one or more embodiments of the present disclosed system and method.

FIGS. 3 and 4 illustrate potential aspects of potential process flows in accordance with one or more embodiments of the present disclosed system and method.

FIG. 5 illustrates a schematic overview of a computing device, in accordance with one or more embodiments of the present disclosed system and method.

FIGS. 6 and 7 illustrate a schematic overview of an embodiment of a system in accordance with one or more embodiments of the present disclosed system and method.

FIGS. 8 and 9 illustrate network diagrams, in accordance with one or more embodiments of the present disclosed system and method.

FIG. 10 illustrates a schematic block diagram, in accordance with one or more embodiments of the present disclosed system and method.

FIGS. 11 and 12 illustrate network diagrams, in accordance with one or more embodiments of the present disclosed system and method.

FIGS. 13 and 14 illustrate schematic block diagrams, in accordance with one or more embodiments of the present disclosed system and method.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

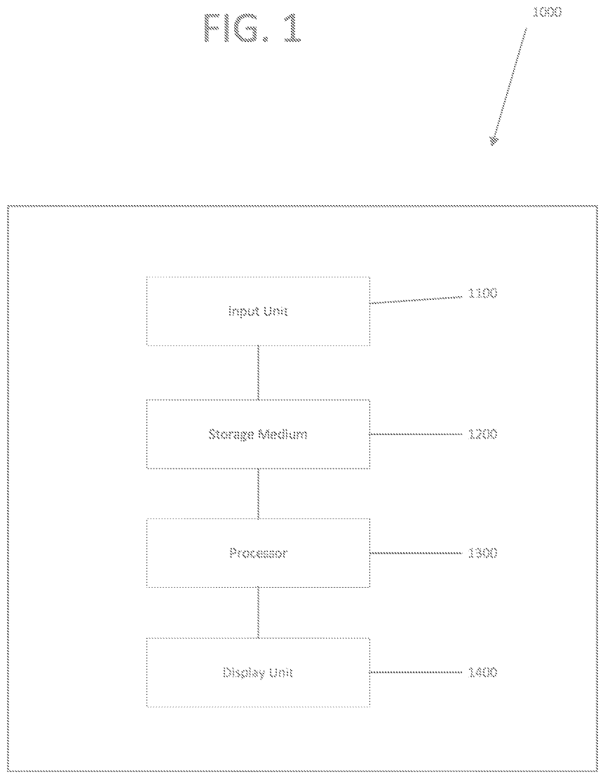

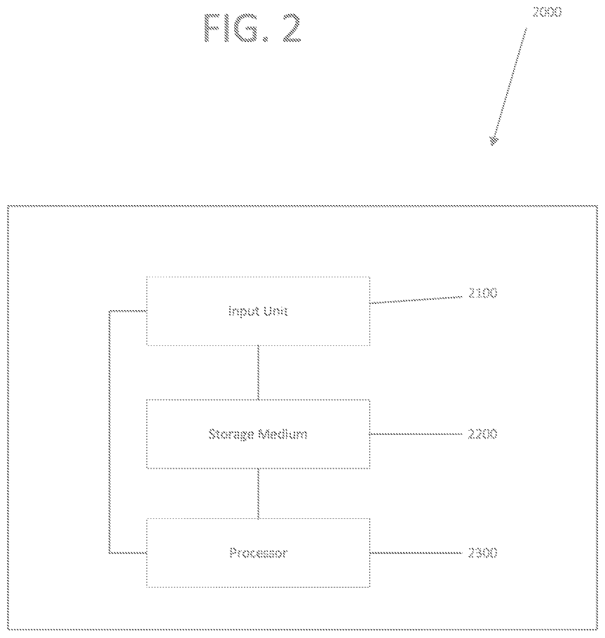

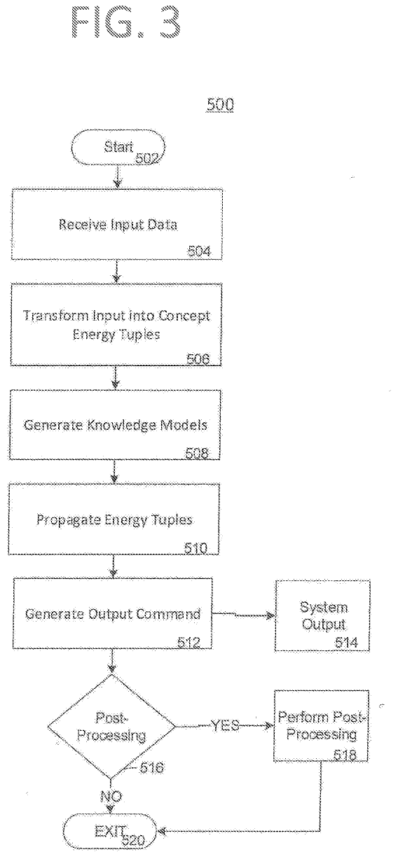

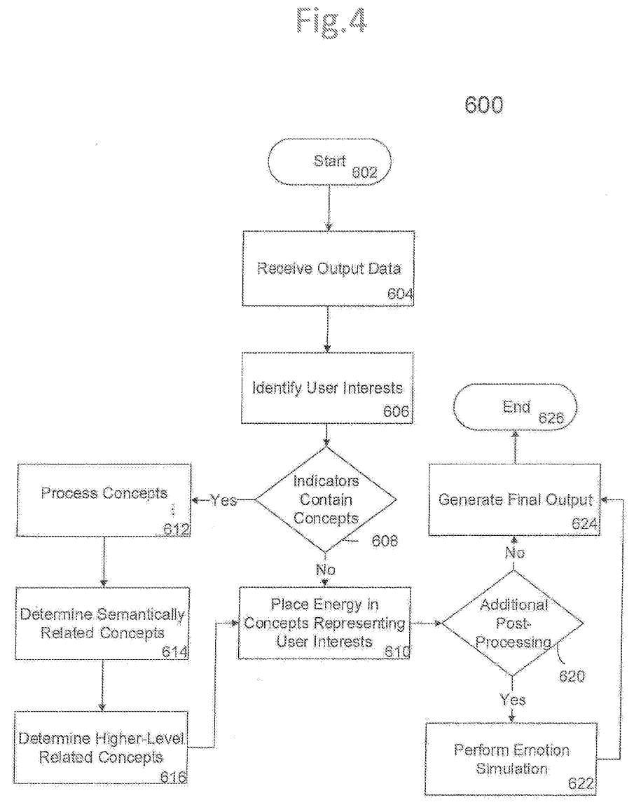

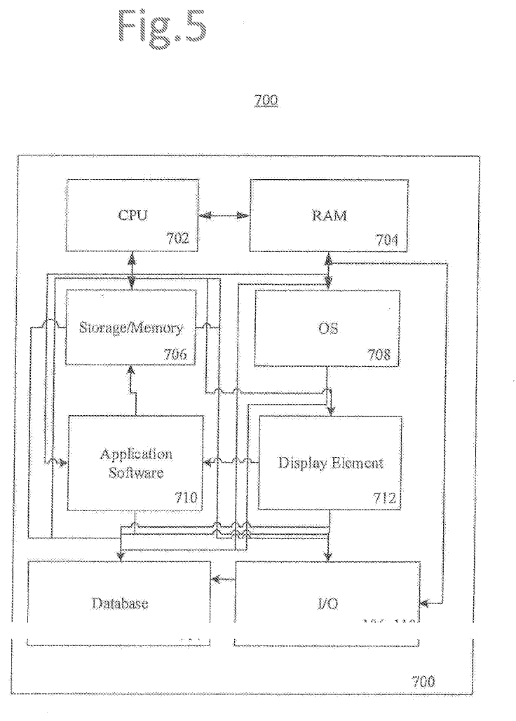

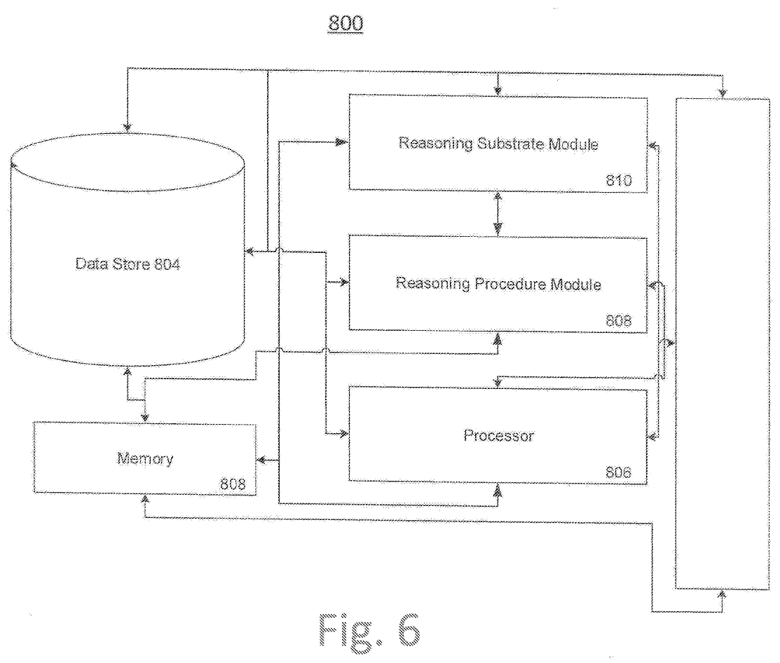

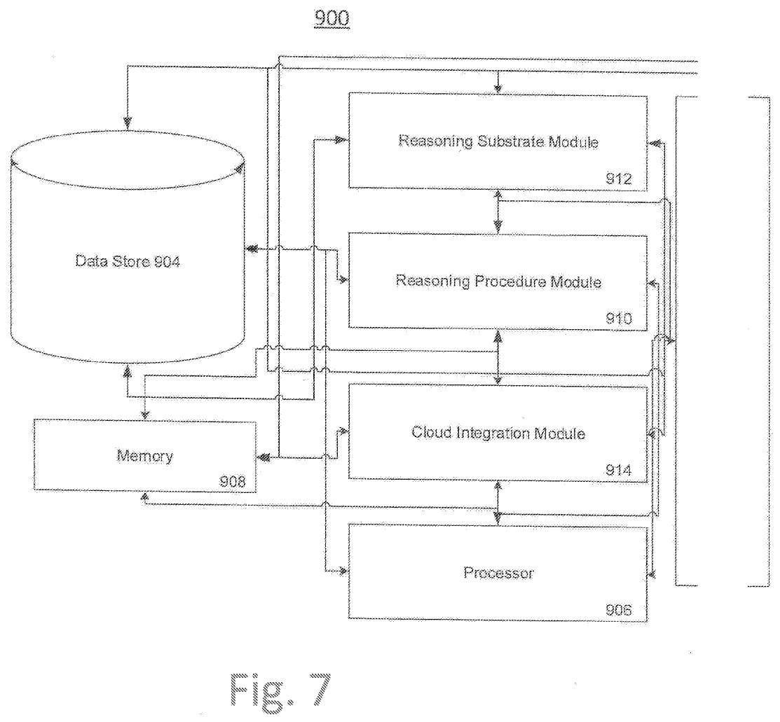

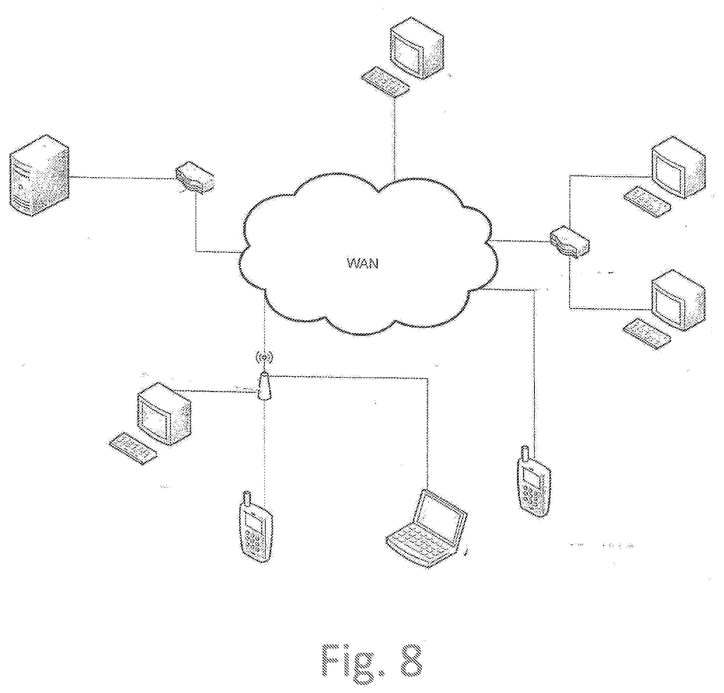

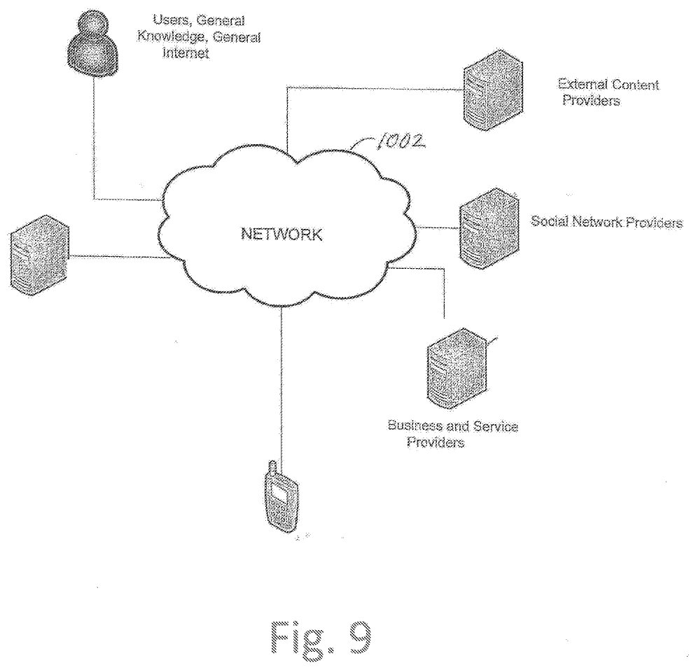

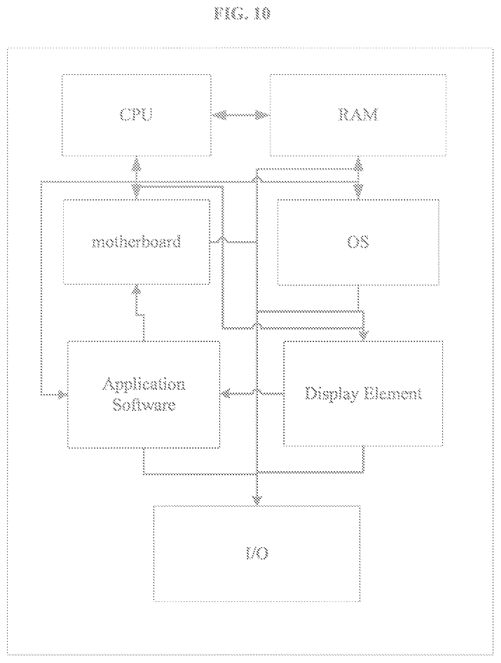

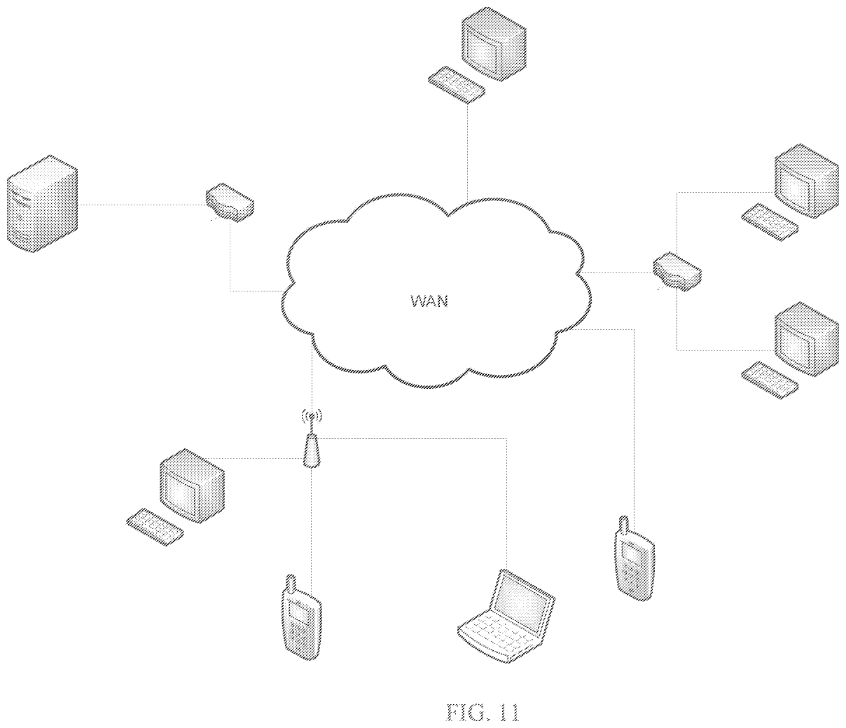

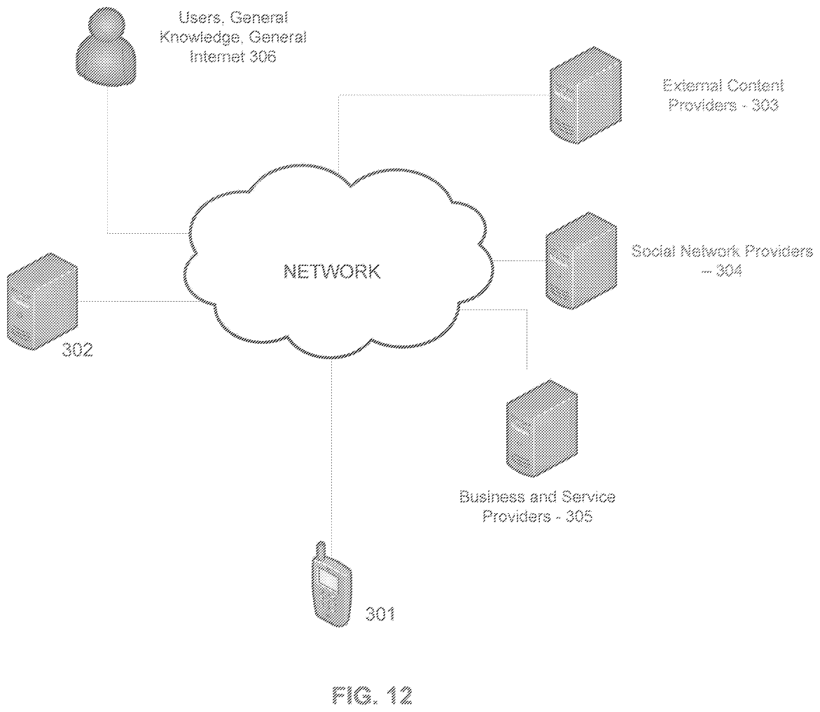

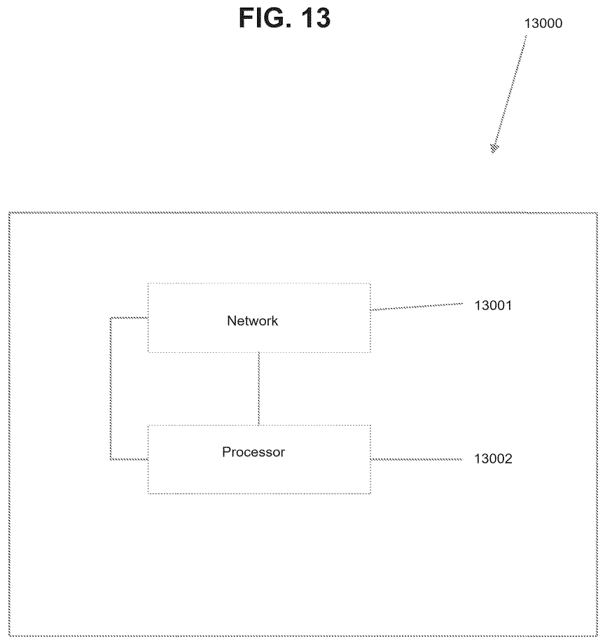

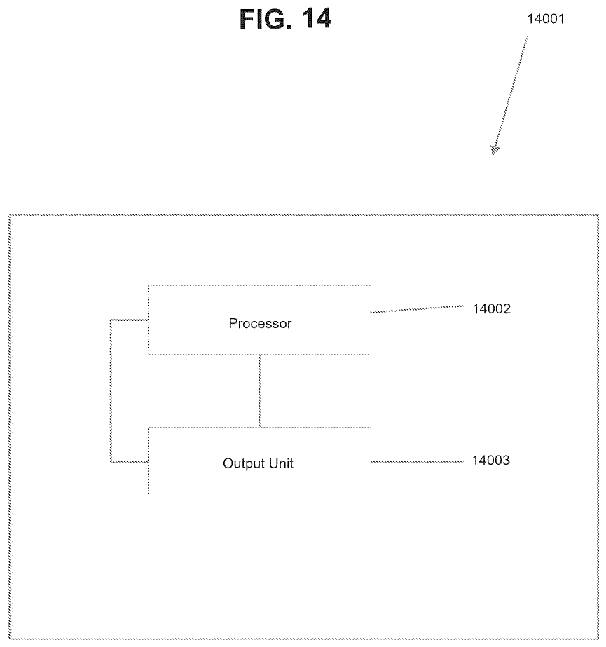

FIGS. 1 and 2 illustrate schematic block diagrams of a system in accordance with one or more embodiments of the present disclosed system and method. FIGS. 3 and 4 illustrate potential aspects of potential process flows in accordance with one or more embodiments of the present disclosed system and method. FIG. 5 illustrates a schematic overview of a computing device, in accordance with one or more embodiments of the present disclosed system and method. FIGS. 6 and 7 illustrate a schematic overview of an embodiment of a system in accordance with one or more embodiments of the present disclosed system and method. FIGS. 8 and 9 illustrate network diagrams, in accordance with one or more embodiments of the present disclosed system and method. FIG. 10 illustrates a schematic block diagram, in accordance with one or more embodiments of the present disclosed system and method. FIGS. 11 and 12 illustrate network diagrams, in accordance with one or more embodiments of the present disclosed system and method. FIGS. 13 and 14 illustrate schematic block diagrams, in accordance with one or more embodiments of the present disclosed system and method.

The system 1000 may include a server 1004, an apparatus 700, and a network 1002, but is not limited thereto.

The server 1004 may include an input unit 1100, a display unit 1400, a processor 1300, a communication unit 802, and a storage unit 804, but is not limited thereto.

The input unit 1100 may include a keyboard, a touchpad, a mouse, a trackball, a stylus, a voice recognition unit, a visual data reader, a camera, a wireless device reader, and a holographic input unit, but is not limited thereto.

The display unit 1400 may include a plasma screen, an LCD screen, a light emitting diode (LED) screen, an organic LED (OLED) screen, a computer monitor, a hologram output unit, a sound outputting unit, or any other type of device that visually or aurally displays data.

A processor (or central processing unit, CPU) may include electronic circuitry to carry out instructions of a computer program by performing basic arithmetic, logical, control and input/output (I/O) operations specified by the instructions. A processor may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. A processor may also include a microprocessor and a microcontroller.

The communication unit 802 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet. As such, the communication unit 802 may allow the server 1004 to access, via the network 1002, any and all information/data related to users, scenarios, situations, and/or contexts that may be stored outside the server 100, and/or information related to any query, question, and/or inquiry that may be stored outside the server 1004.

The storage unit 804 may include a random access memory (RAM), a read-only memory (ROM), a hard disk, a flash drive, a database connected to the Internet, cloud-based storage, Internet-based storage, or any other type of storage unit.

The storage unit 804 may store any and all information/data related to users, scenarios, situations, contexts, domain knowledge, and/or information related to any query, question, and/or inquiry.

Furthermore, the storage unit 804 may store data related to the user, scenario, situation, and/or context as first data, data related to the query as second data, and domain information as third data.

The term “data” may be synonymous to the term “information,” and merely describes any type of knowledge or information.

A user may input any/all the above data/information via the input unit 1100.

Alternatively, a machine 1 may use (i.e., execute, run, etc.) an automated process to input any/all the above data/information.

The machine 1 can be any type of machine known to one of ordinary skill in the art, and may include a computer, a mobile device, a server, a computer system, a cloud-based system, a parallel-computer system, and an automated system (e.g., an artificial intelligence system), but is not limited thereto.

A processor may perform data analysis based on a subset of data including at least a portion of the first data merged with at least a portion of the second data and/or the third data.

More specifically, various data elements in the first data may converge and associate (e.g., merge) with various data elements in the second data and/or the third data, in order to generate a new subset of data. Then, a processor may analyze the new subset of data alone or with respect to any other fourth data that is different from the first data, the second data, and the second data, in order to provide an optimal answer to whatever inquiry was presented, in real-time. The result of the analysis may be output from a processor to the display unit 1400 to be displayed thereon, or alternatively, may be output from a processor to the communication unit 802 to be transmitted to another external and/or internal device or apparatus. Any generation of data may be performed autonomously by a processor.

A device may be a mobile phone, a laptop computer, a tablet computer, a desktop computer, a server computer, a palm pilot, a smart watch, etc., but is not limited thereto, and may be any type of mobile device that connects to the Internet or any other type of network. In other words, a device may also be referenced as an apparatus, for at least the reason that a mobile device (a.k.a., apparatus) may be movable or stationary, depending on a user's preference.

A device may include an input unit, display unit, a processor, a communication unit, and a storage unit.

The input unit may include a keyboard, a touchpad, a mouse, a trackball, a stylus, a voice recognition unit, a visual data reader, a camera, a wireless device reader, and a holographic input unit.

A display unit may include a plasma screen, an LCD screen, a light emitting diode (LED) screen, an organic LED (OLED) screen, a computer monitor, a hologram output unit, a sound outputting unit, or any other type of device that visually or aurally displays data.

A processor (or central processing unit, CPU) may include electronic circuitry to carry out instructions of a computer program by performing basic arithmetic, logical, control and input/output (1/O) operations specified by the instructions. A processor may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. A processor may also include a microprocessor and a microcontroller.

A communication unit may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

A storage unit may include a random access memory (RAM), a read-only memory (ROM), a hard disk, a flash drive, a database connected to the Internet, cloud-based storage, Internet-based storage, or any other type of storage unit.

An apparatus may receive the result of the analysis, or alternatively, may receive the first data and the second data, and may perform data analysis.

Communication may occur via any type of network, including the Internet, an Intranet, intra-office connections, or inter-office connections.

A network may include at least one of the Internet, a cellular network, a universal mobile telecommunications systems (UMTS) network, a Long Term Evolution (LTE) network, a Global System for Mobile Communications (GSM) network, a 5G network, a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. A network can be implemented with any number of hardware and software components, transmission media, and network protocols. Embodiments shown with a single network are not limited thereto.

Any outputs generated may be displayed on a display unit. Likewise, any outputs generated by an apparatus may be displayed on the on a display unit.

In summation, in some embodiments the system 1000 may have a program executed thereon to answer a query, such that the system 1000 stores and/or access information related to the user, scenario, situation, and/or context, to store and/or access information (e.g., data) defining the query, and to store and/or access domain information.

A system may optionally include an input unit, a display unit, a communication unit, information, one or more queries, domain information, one or more entities, one or more facilitators, one or more organizations, one or more customers, one or more businesses, one or more clients, one or more knowledge providers, knowledge, one or more rewards, and a processor. A system may optionally process information related to a user, a scenario, a situation, and/or context. A system may optionally provide an answer to a query based on information related to at least one of user, scenario, situation, and/or context, information, and domain information. After all the information is processed, a display unit may optionally display at least one answer to at least one query.

The information referenced above may be categorized into various types of information, including, but not limited to, information related to the user, scenario, situation, and/or context, information defining the query, and domain information.

### Information Related to the User

The information related to the user (i.e., user information) may be referred to as first information 10.

The first information 10 may include any and all information related to the user, including, but not limited to, information that may be tangentially related to the user, information regarding a personality of the user, information about the user's medical history, information about the user's preferences, information regarding the user's work history, information about the user's personal history, etc. In other words, the first information 10 may be a grouping and/or record of stored information (a.k.a., knowledge), regarding every possible thing about the user. Moreover, since the user is constantly ageing and changing, the first information 10 may be updated constantly and/or dynamically within the system 1000.

However, although the first information 10 may include basic information about the user, such as the user's age, the user's gender, the user's height, the user's weight, etc., the first information 10 may additionally include information that may be surmised/deduced about, or associated with, the basic information about the user. In other words, the goal of the system 1000 is to look at real-world applications of the first information 10 with regard to the user, which requires an additional step of analyzing basic information about the user, in order to deduce and/or surmise new information and/or generalized information that may apply to the user and/or a group of users.

For example, although the system 1000 may have access to information that the user is 60 years old, is male, has a height of 6′6″, and weighs 300 pounds, the actual information that is relevant to and used by the system 1000 is information that is associated with the above characteristics, such as “a 60 year old male will be subjected to specific aging processes, which could have implications on medical procedures that the user needs”, “a 6′6″ male weighing 300 pounds may have an elevated BMI, which would imply various elements of the person's health and potential medical conditions,” etc., but is not limited thereto.

As such, the first information 10 may be subdivided into two types of information, namely information that is part of the user's universe as described above (i.e., general user information 11), and information regarding the user's idiosyncrasies (i.e., idiosyncratic user information 12).

The general user information 11 may include information that may be shared by a variety of users, such as “a 6′6″ male weighing 300 pounds may have an elevated BMI, which would imply various elements of the person's health and potential medical conditions.” However, this information, of course may be included for a particular user that has the requisite traits of being a male standing at 6′6″ and weighing 300 pounds, for at least the reason that user information related to a female standing at 5″6″ and weighing 120 pounds would not include general information that is relevant to this particular user.

The idiosyncratic user information 12 may include any type of information that is unusual about the user and/or individualized about the user, such as the user's favorite color, the user's disabilities, the user's favorite band, etc., but is not limited thereto.

Therefore, for example, if the user were to input a query into the system 1000, such as, “what house should I purchase,” the first information 10 that may be accessed by the system 1000 may include information such as locations where the user has previously lived and the impact this has had on the user, locations where the user has experienced happiness, a family size of the user and the requirements associated therewith, a monetary status of the user and the implications associated therewith, temperature preferences of the user, types of houses preferred by the user, etc. However, this is just a small sampling of the first information 10 (including the general user information 11 and the idiosyncratic user information 12, which may be utilized by the system 1000 to answer the query of “what house should I purchase,” for at least the reason that much more information/knowledge may be needed about the user and/or information associated with the user, in order to provide a proper answer that is customized for the user and that is in the best interest of the user.

The first information 10 may be input directly into the system 1000, or any portion of the system 1000.

Alternatively, the system 1000, or any portion of the system 1000 may access the first information 10 from any electronic and/or non-electronic source, such as the Internet, search engines, websites, mobile applications, social media, government records, satellites, books, newspapers, magazines, etc., but is not limited thereto.

Furthermore, the system 1000 may access the first information 10 if it is stored in at least one storage unit.

Information Related to the Scenario, Situation, and/or Context

The information related to the scenario, situation, and/or context (i.e., scenario, situation, and/or context information) may also be referred to as the first information 10.

The information related to the scenario, situation, and/or context may include at least one of general information about the scenario, situation, and/or context, idiosyncratic information about the scenario, situation, and/or context, information that is surmised about the scenario, situation, and/or context, information that is deduced about the scenario, situation, and/or context, information that is associated with the scenario, situation, and/or context, information that is tangentially related to the scenario, situation, and/or context, information that is directly related to the scenario, situation, and/or context, information regarding a history of the scenario, situation, and/or context, information about general preferences, information regarding the causal components of, contents of, participants in, and/or influences on the scenario, situation, and/or context, and information that explains and/or describes the scenario, situation, and/or context, etc. In other words, the first information 10 may be a grouping and/or record of stored information (a.k.a., knowledge), regarding every possible thing about the scenario, situation, and/or context. Moreover, since the scenario, situation, and/or context are continually changing, the first information 10 may be updated constantly and/or dynamically within the system 1000.

The first information 10 may additionally include information that may be surmised/deduced about, or associated with, the basic information about the scenario, situation, and/or context. In other words, the goal of the system 1000 is to look at real-world applications of the first information 10 with regard to the scenario, situation, and/or context, which requires an additional step of analyzing basic information about the scenario, situation, and/or context, in order to deduce and/or surmise new information and/or generalized information that may apply to the scenario, situation, and/or context, related scenarios, situations, and/or contexts, and/or sequelae thereof.

The first information 10 may be subdivided into two types of information, namely information that is generally part of the scenario, situation, and/or context as described above (i.e., general scenario, situation, and/or context information 11), and information regarding the specific current state of the scenario, situation, and/or context (i.e., idiosyncratic scenario, situation, and/or context information 12).

The first information 10 may be input directly into the system 1000, or any portion of the system 1000.

Alternatively, the system 1000, or any portion of the system 1000, may access the first information 10 from any electronic and/or non-electronic source, such as the Internet, search engines, websites, mobile applications, social media, government records, satellites, books, newspapers, magazines, etc., but is not limited thereto.

Furthermore, the system 1000 may access the first information 10 if it is stored in at least one of a storage unit of the server 100 and a storage unit of a device.

### Information Defining the Query

The information defining the query may be referred to as second information 20. The second information 20 may include any and all information that is required to define the query.

For example, if the user were to input the query “what house should I purchase,” the system 1000 may access the second information 20 that may include information, including, but not limited to, “the user is seeking a place to live,” “the user desires to live in a house,” “the user wants to purchase a house,” etc.

In other words, the information defining the query may include information that parses or interprets the query to allow the processor to understand the query. As such, the second information 20 may include the query as an entity that has been analyzed, by the system 1000, into a plurality of parts, such that each part can be described and understood by its separate (but coalescent) syntactic roles.

The second information 20 may include at least one utility function and/or other means of defining or identifying success, user goals, and/or specifically or generally desirable goals or outcomes.

The second information 20 may include a set of safety limitations, authority limitations, guidelines, and/or other information intended to guide the system 1000 as to what actions it may take and/or decisions it may make autonomously without human guidance (the limitations 2003). During operation, the system 1000 is able to continually ensure it is in accordance with these limitations. Should the system 1000 encounter a question or situation that it cannot resolve within its given limitations, it may notify the user of the situation and/or ask for guidance.

The second information 20 may be input directly into the system 1000, or any portion of the system 1000.

Alternatively, the system 1000, or any portion of the system 1000, may access the second information 20 from any electronic and/or non-electronic source, such as the Internet, search engines, websites, mobile applications, social media, government records, satellites, books, newspapers, magazines, etc., but is not limited thereto.

Furthermore, the system 1000 may access the second information 20 if it is stored in at least one storage unit.

### Domain Information

The domain information may be referred to as third information 30. The third information 30 may include information related to the query. Specifically, the third information may be potentially semantically relatable to the query, for at least the reason that there may not be a direct relationship between the third information 30 and the query, but instead, the relationship may be semantic and/or determined by several degrees of separation. As such, the system 1000 may not even determine which third information 30 is most relevant to the query until a simulation is executed, which will be explained later.

The third information 30 may be static and/or dynamic, meaning that the third information may have a tendency to stay the same over time (i.e., static domain information 31), or may have a tendency to change over time (i.e., dynamic domain information 32). Although the term “static” typically refers to something that never changes and/or stays constant, with reference to the present general inventive concept, the term “static” may include information that usually does not change, but may change later in time based on a state and/or condition of the world.

For example, if the user were to input the query “what house should I purchase,” the third information 30 may include the static domain information 31 including, but not limited to, “houses provide shelter,” “winters in Florida are statistically warmer than winters in Chicago,” “stairs require the ability to walk,” “Washington DC is politically democratic,” etc. However, the static domain information 31 of “Washington DC is politically democratic” could potentially change in the future, but the chances of such a change occurring is highly unlikely.

As another example, if the user were to input the query “what house should I purchase,” the third information 30 may include the dynamic domain information 32 including, but not limited to, lists of houses available on the market, lists of houses currently in foreclosure, lists of houses within a particular price range, etc. However, all of the above information is dynamic, as this dynamic domain information 32 may change on a daily basis.

Also, the third information 30 may include information that is directly related to the query, and/or, information that is ancillary to the query. Referring above, an example of third information 30 that is directly related to the query includes the lists of houses available on the market, because this information is required to answer the query. Alternatively, an example of third information 30 that is ancillary to the query includes the fact that “cities have traffic problems,” because it may or may not be important for the system 1000 to consider the traffic differences between cities, counties, and rural areas. However, the system 1000 will not know whether this information is important, until a simulation is executed.

The third information 30 may be input directly into the system 1000, or any portion of the system 1000.

Alternatively, the system 1000, or any portion of the system 1000, may access the third information 30 from any electronic and/or non-electronic source, such as the Internet, search engines, websites, mobile applications, social media, government records, satellites, books, newspapers, magazines, etc., but is not limited thereto.

Furthermore, the system 1000 may access the third information 30 if it is stored in at least one of a storage unit of the server 100 and a storage unit of a device.

### Executing Simulations Using the System 1000

In order to answer the input query, the system 1000, and/or components thereof, may execute (a.k.a., run, process, etc.) at least one simulation including the first information 10, the second information 20, and the third information 30, but is not limited thereto and may include any combinations of the first information 10, the second information 20, and the third information 30, based on the input query.

Specifically, after the user and/or the machine 1 running the automated process inputs the query into an input unit, a processor may utilize the first information 10, the second information 20, and/or the third information 30, or any combination thereof, in order to execute the at least one simulation. Alternatively, the execution of the at least one simulation may occur outside the system 1000, in a cloud-based system, etc., but is not limited thereto.

The at least one simulation that is executed by the system 1000, may include a simulation that includes combinations of the first information 10, the second information 20, and/or the third information 30. Specifically, the at least one simulation may be executed as a scenario and/or process that includes various combinations and/or variations of the first information 10, the second information 20, and/or the third information 30.

After the at least one simulation is executed by the system 1000, the system 1000 outputs at least one answer to the query that is best suited for the user, user goals, general goals, and/or applicable utility functions, such that the answers to the query may be displayed on a display unit. The answers that are best suited for the user, user goals, general goals, and/or applicable utility functions may be determined using a scoring and/or ranking of various answers produced by various simulations. In other words, as various different combinations of the first information 10, the second information 20, and/or the third information 30 are utilized by various simulations, the system 1000 may provide a score/rank for each result/answer, such that the best answers for the user, user goals, general goals, and/or applicable utility functions are those answers that are produced by the simulations producing the best scores and/or best ranks. As such, although the user may not agree that the answer presented by the system 1000 is what the user consciously wanted or predicted, the system 1000 may output the answers that are in the user's best interest and/or best capable of satisfying user goals, general goals, and/or applicable utility functions.

The at least one answer to the query (a.k.a., a “query answer”) generated by the system 1000 after the performed simulation may include a plurality of simulation information 2000 that may help the user understand how the system 1000 developed the query answer. The plurality of information 2000 may include first simulation information 2010, second simulation information 2020, third simulation information 2030, and fourth simulation information 2040, as will be described in detail below.

The first simulation information 2010 may be related to metrics, indicators, Key Performance Indicators (KPIs), and/or other mechanisms that may allow the user to determine how he/she should view and/or measure the situation, context, and/or problem giving rise to the query. In some embodiments, the first simulation information 2010 may be utilized by the user to understand how ‘good’ should be construed and/or to adjust the user's actions accordingly. The first simulation information 2010 may also include information on accountability, namely, which first simulation information 2010 is most important from an accountability perspective, who should be held accountable, how they may be held accountable, how accountability may be verified, and/or other relevant information. For example, if the system 1000 were to run a simulation based on the query “what car should I purchase?”, the first simulation information 2010 may include information such as “cars with efficient gas mileage are good,” “cars that are constructed with safety features are good,” “cars that drive fast are good,” “cars that have ample leg room are good,” etc.

The second simulation information 2020 may be related to metrics, indicators, and/or other mechanisms that may allow the user to determine whether or not the situation, context, and/or problem giving rise to the query is proceeding along the lines and/or in the manner envisioned by the user and/or the system 1000. The information 2020 may include specific details on what to expect in future, the reasons why this is expected, the implications of these expectations, various ways in which those expectations may not be met, the implications of those expectations not being met, the severity of those implications not being met, general guidance on how to proceed in light of expectation failure, the relative importance of expectation violations, and/or the conditions under which the query should be re-run. In other words, the second simulation information 2020 may include indicators that show whether something is working properly and/or is the best-case scenario. Using the above example, during the simulation, many different cars may be put through the simulation, during which the system 1000 would determine whether the car runs well, the cars reach their destinations, the cars last for a long time without break-down, etc.

The third simulation information 2030 may be related to explanations, justifications, and/or other expository content intended to allow the user to understand the reasons for and/or justification, including without limitation causal justification, for the output generated. The information 2030 is also intended to enable the user to better understand the context of the problem and the context under which the output was generated. Using the above example again, the query answer to the input query of “what car should I purchase?” may be answered by the system 1000 as “Mercedes.” The third simulation information 2030 may include information regarding the justification for the system 1000 outputting “Mercedes,” such as “Mercedes are safe cars,” “Mercedes are well-constructed,” “Mercedes are fast cars,” etc.

The fourth simulation information 2040 may be related to various safety rules and/or guidelines that are inherently required by the system 1000. In order words, the fourth simulation information 2040 may include information that maintains the system 1000 as a failsafe, appropriate, and non-dangerous system. As such, using the above example, the system 1000 would make sure that dangerous cars would not be output as potential query answers, as the system 1000 is designed to inherently protect people.

Additionally, the second information 20 may include a set of safety limitations, authority limitations, guidelines, and/or other information intended to guide the system 1000 as to what actions it may take and/or decisions it may make autonomously without human guidance, which may be related to the fourth simulation information 2040. During operation, the system 1000 is able to continually ensure it is in accordance with these limitations. Should the system 1000 encounter a question or situation that it cannot resolve within its given limitations, it may notify the user of the situation and/or ask for guidance.

To perform the scoring and/or ranking, the system 1000 may compute real-world impacts and/or implications of various things, and may be able to discover how desirable those real-world impacts will be. The system 1000 may score different impacts on various scales, and may take these impacts into account when generating answers.

In certain embodiments, the system 1000 may perform any and all simulations without taking desires, preferences, or theories into consideration. For example, although a user may inherently believe that cold weather is worse than warm weather, this theory may inherently cause the user to make flawed and imperfect decisions. In contrast, the system 1000 does not inherently surmise that cold weather is worse than warm weather, but instead, performs simulations including various information to generate an answer that is theory-free and which does not reify any particular notion, item, desire, belief, or preference. As such, the system 1000 may generate solutions to queries based on simulations executed to include all and/or portions of the first information 10, the second information 20, and/or the third information 30.

Specifically, using the above example, if the user inputs the query “what house should I purchase,” the system 1000 may utilize the first information 10 (i.e., the user information), the second information 20 (i.e., the query information), and the third information 30 (i.e., the domain information), in order to execute simulations on a plurality of houses to determine which houses are the best fit for the user. As a simplified example, if the idiosyncratic user information 12 includes the fact that the user only wants to live in Baltimore City, and the dynamic domain information 32 includes the fact that there are 10 houses available on the market, then the system 1000 would execute 10 simulations (i.e., one simulation per house) including all of the first information 10, the second information 20, and the third information 30, in order to produce scores related to each executed simulation, in order to verify which houses are the best fit for the user based on the best scored simulations.

The system 1000 may select from alternatives using a scoring and/or ranking methodology/system that is similar to a utility function (i.e., a function that ranks alternatives based on their utility for the user and/or other relevant stakeholders). In order words, as the simulations are executed, each piece of information and/or combination of information within each simulation is given a score and/or rank. Accordingly, as stated above, the simulations that produce the best scores and/or ranks may be those simulations that are used by the system 1000 to output answers to the query.

Although the above example included the idiosyncratic user information 12 including the fact that the user only wants to live in Baltimore City, the system 1000 does not require such detailed information, and alternatively, may execute hundreds of simulations in order to determine query answers.

The following includes a myriad of examples and/or applications of the system 1000, specifically, generalized queries that the user and/or the machine 1 running the automated process may input into an input unit. The following examples are provided only to illustrate the universality of the system 1000, and these examples are in no way an exhaustive list of the limitations of the system 1000. On the contrary, this list of examples is provided to help the reader understand the many various capabilities of the system 1000. Although the user and/or the machine 1 running the automated process may also input queries into an input unit, for ease of explanation, the following examples and/or applications will be limited to queries that are input into an input unit of a device. Each of the following applications may optionally include one or more explanations as provided by the third simulation information 2030; the presence or absence of any reference to explanation, justification, etc. is solely for expository purposes and conveys no further meaning.

### Query—Where Should I Live?

The user may use an input unit to input a generalized query, such as “where should I live?” The query may optionally be sent from a device through a network.

A processor may interpret the query as the second information 20 in order to gather information that may specifically define the query. As such, the second information 20, in this case, may include information including, but not limited to, “the user is seeking a place to live,” “the user desires to live in a particular location,” “the user is seeking a particular type of edifice in which to live,” etc.

A processor may then access the first information 10 (i.e., information related to the user) either from a storage unit, and/or from external sources. As stated above, alternatively, a device itself may include the first information 10 stored within a storage unit, or may access the first information 10 via a communication unit 240 or via some other means.

The first information 10 may include the general user information 11 and/or idiosyncratic user information 12. Thus, the first information 10 may collectively include, but is not limited to, a marital status of the user, a child status of the user (i.e., how many children, if any, does the user have), a personality type of the user, an education level of the user, a profession of the user, temperature preferences of the user (e.g., cold, snowy, warm, moderate, hot/tropical, rainy, humid, etc.), location preferences of the user (e.g., fast-paced, city, urban, suburban, county, country, etc.), implications that a particular location would have of the user, housing preferences of the user (e.g., mansion, stand-alone house, townhouse, apartment, condo, time-share, etc.), implications that a particular type of housing would have on the user, payment abilities of the user (e.g., cash purchase, finance purchase, lease/rent, lease with sublease, etc.), potential roommate necessities of the user, implications of having a roommate with respect to the user, number of bedrooms/bathrooms desired/required for the user, a salary of the user, any relevant criminal records of the user that need to be overcome, etc., but is not limited to the above information related to the user, and may include any information available on social media, the Internet, data files, records, etc.

A communication unit may also access the third information 30 in order to gather information related to the query. As such, a communication unit may access user profiles, social media, external servers, data, websites, or any other type of information related to property-listing databases, location-specific statistics, school ranking databases, crime statistic databases, maps, blogs, profiles, social media, external servers, data, websites, or any other type of information related to housing and/or properties, and may find information customized to the user's needs and desires. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine where the user should live.

Specifically, a processor may run simulations using the first information 10 (i.e., information related to the user) with respect to various different potential places to live for the user, which would be part of the third information 30 (i.e., the domain information), in the context of the second information 20. Each simulation is scored and/or rated, and the best scored and/or rated simulation is interpreted to include the best matched living location for the user. As such, a display unit may display the best result of the simulation, which will be the place(s) where the user should live.

Also, a display unit may display a portion of the results of the simulation, such as the top 10 simulation results, and create a list of potential best-matched houses and/or properties for the user.

Alternatively, a device may access the above information directly, or may acquire it via a communication unit, and then may process the information using a processor in order to determine where the user should live. Subsequently, a display unit may display a list of potential best-matched houses and/or properties for the user.

It is important to note that the system 1000 does not only utilize information and knowledge that is obviously available about the user, such as the number of children the user has. Instead, the system 1000 infers values related to all the knowledge available about the user, in order to deduce and surmise various effects that various properties and/or locations may have on the user. In other words, the system 1000 evaluates at each property that is available, and it simulates the user actually living there. Other factors that the system 1000 may consider are each property's distance to the user's work location, noisiness of each location, degrees of happiness the user would experience at least living location, etc. Specifically, the system 1000 is designed to simulate placing the user in each available property, and evaluating how the user would feel living in that particular property. As such, the system 1000 does not match elements or criteria for the user, but instead creates a mini universe and simulates how each property would potentially affect the user's universe. The same aforementioned principles may be applied to each potential query that the user may input into the system 1000

As such, the user's generalized question of “where should I live?” is answered by the system 1000, such that the system 1000 outputs a specific answer that is tailored to the user.

Additionally, although the system 1000 is designed to allow the user to simply input the single question of “where should I live,” and then output a customized answer for the user, the system 1000 may display one or two questions on a display unit to further narrow-down options for the user. For example, the system 1000 may display questions that may be answered by the user, such as, “would you like to rent or buy?” and/or “which country do you want to live in?”, in order to delineate with even more accuracy, the types of properties and locations that the system 1000 should focus on in order to better and more accurately tailor the answer for the user.

The same and/or similar types of above information and/or processes may be used to answer similar questions/queries, including, but not limited to, “what house or apartment should I rent?”, “what house should I purchase and fix up?”, “what house should I purchase as an investment?”, “what world culture should I live in?”, “what should I fix up in my house to raise its value?”, “given my present holistic career, life circumstances, interests, coming economic future, etc. should I buy or rent my home?”, etc. However, the differences between these questions may be controlled by the second information 20, which would define each query, and include specific information including, but not limited to, “the user wants to live in a particular edifice without owning it,” “the user desires to purchase a house at a cheaper price and then fix it up,” “the user wants to purchase a home that will have a good resale value,” “the user wants to maximize the user's happiness with regard to living in a particular location and within a particular culture,” “the user wants to increase the value of the user's home by making home improvements,” etc.

### Query—Who Should I Date?

The user may use an input unit to input a generalized query, such as “who should I date?” The query may optionally then be sent from a device through a network via a communication unit.

A processor may interpret the query as the second information 20 in order to gather information that may specifically define the query. As such, the second information 20, in this case, may include information including, but not limited to, “the user is seeking a partner,” “the user is seeking a partner for a potential romantic relationship,” “the user is seeking a partner who is a best match for the user,” etc.

A processor may then access the first information 10 (i.e., information related to the user) either from a storage unit and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications regarding gender of the user, general behavior of a person having a particular marital status as related to the user (married, separated, divorced, single, etc.), the sexual orientation of the user, a personality type of the user, a hair preference of a potential mate for the user, other preference of a potential mate for the user, an eye color preference of a potential mate for the user, a height preference of a potential mate for the user, a religion of the user, a political preference of the user, a dietary preference of the user, an education level of the user, a profession of the user, hobbies of the user, emotional characteristics of the user, faults of the user, professional goals of the user, social goals of the user, child-rearing preferences of the user, a number of children that the user desires, a daily schedule/itinerary of the user, public records of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to potential mates for the user, and may find information related to potential mates for the user that is similar to the above information gathered about the user. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine who the user should date.

Specifically, a processor may run simulations using the first information 10 (i.e., information related to the user) with respect to various different potential mates for the user, which would be part of the third information 30 (i.e., the domain information), in the context of the second information 20. Each simulation is scored and/or rated, and the best scored and/or rated simulation is interpreted to include the best match for the user. As such, a display unit may display the best result of the simulation, which will be the person(s) that the user should date.

Also, a display unit may display a portion of the results of the simulation, such as the top 10 simulation results, and create a list of potential best-matched mates for the user.

Alternatively, a device may access the above information directly, or may acquire it via a communication unit, and then may process the information using a processor of a device in order to determine who the user should date. Subsequently, a display unit of a device may display a list of potential best-matched mates for the user.

As such, the user's generalized question of “who should I date?” is answered by the system 1000, such that the system 1000 outputs a specific answer that is tailored to the user.

The same and/or similar types of above information and/or processes may be used to answer similar questions/queries, including, but not limited to, “who should I marry?”, “who should I be friends with?”, “who should I hang out with?”, “who should I meet?”, “who should I eat lunch with?”, “since I am a particular type of person, who should I date to maximize my happiness?”, etc. However, the differences between these questions may be controlled by the second information 20, which would define each query, and include specific information including, but not limited to, “the user wishes to spend the rest of the user's life with another person,” “the user desires to develop a platonic relationship with another person,” “the user wants to spend a limited amount of time with another person,” “the user desires to have an encounter with a particular type of person,” “the user wants to share a meal with someone,” etc.

Also, the system 1000 may also include detailed analysis of relationship patterning to teach users about relationships in general, and then may adapt to the user's specific world and relationship in order to give the user tailored guidance (e.g., What does ‘right’ look like in relationships/your relationship? What to do to get to the relationship you want? How is our relationship doing? How can we overcome conflict? How can we fix relationship problems? Find atypical attractions? Do you prefer people who have certain characteristics? Do you prefer people that enjoy certain activities?)

Query—What Tech should I Use in My Business?

The user may use an input unit to input a generalized query, such as “what tech should I use in my business?” The query may then be sent from a device.

A processor may interpret the query as the second information 20 in order to gather information that may specifically define the query. As such, the second information 20, in this case, may include information including, but not limited to, “the user has a business,” “the user has a particular type of business,” “the user's business requires technology,” “the user's business requires a specific type of technology,” etc.

A processor may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, traits of a user that may own a particular type of business, types of technology that the user is comfortable with and/or uncomfortable with, an education level of the user, and a profession of the user, and may include any information available on social media, the Internet, data files, records, etc.

A communication unit may also then access the third information 30 in order to gather information related to the query. As such, a communication unit may access user profiles, social media, external servers, data, websites, or any other type of information related to what is involved in running the particular business that the user owns, impacts of technology on various businesses, and/or information regarding technology/technological devices that are best suited and/or worst suited for the user's type of business. Moreover, the third information 30 may include information that may be deduced from technological impacts of various technologies/technological devices on various types of businesses. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what type of technology is best-suited for the user.

Specifically, a processor may run simulations using the first information 10 (i.e., information related to the user) with respect to various different types of technologies and/or technological devices that are used in the user's specific business, which would be part of the third information 30 (i.e., the domain information), in the context of the second information 20. Each simulation is scored and/or rated, and the best scored and/or rated simulation is interpreted to include the best match for the user with respect to the user's business. As such, a display unit may display the best result of the simulation, which will be the various types of technologies and/or technological devices that the user should include in the user's business.

Also, a display unit may display a portion of the results of the simulation, such as the top 10 simulation results, and create a list of various types of technologies and/or technological devices that the user should include in the user's business.

Alternatively, a device may access the above information directly, or may acquire it via a communication unit and then may process the information using a processor in order to determine the various types of technologies and/or technological devices that the user should include in the user's business. Subsequently, a display unit of a device may display a list of various types of technologies and/or technological devices that the user should include in the user's business.

As such, the user's generalized question of “what tech should I use in my business?” is answered by the system 1000, such that the system 1000 outputs a specific answer that is tailored to the user.

The same and/or similar types of above information and/or processes may be used to answer similar questions/queries, including, but not limited to, “who should I hire?”, “what marketing techniques should I use in my business?”, “who should I recruit?”, “what corporate moves should I make?”, what menu items should I include in my restaurant?”, “what should I charge for my goods/services/products?”, “who should run a business?”, etc. However, the differences between these questions may be controlled by the second information 20, which would define each query, and include specific information including, but not limited to, “the user wishes to employ a new person,” “the user desires to increase business recognition in the marketplace,” “the user wants to persuade a person to work at the user's company,” “the user desires to increase business revenue/success in the near future,” “food served should be appropriate for the demographic/area,” “prices should be affordable,” “a leader should be best suited for a particular business,” etc.

### Query—How to Understand and Resolve a Particular Crisis

The user may use an input unit to input a generalized query that is not necessarily in a question form, such as “how to understand and resolve a particular crisis.” The query may then be sent from a device. However, this particular query is extremely general, and the system 1000 may output a secondary question after analyzing the query, such as “what is your particular crisis?” If this is the case, then the user may input a secondary query and/or response with additional information, such as “my employees are stealing from the company.” This is only an example, and any crisis could be input by the user.

A processor may interpret the query as the second information 20 in order to gather information that may specifically define all of the information provides by the queries. As such, the second information 20, in this case, may include information including, but not limited to, “the user is seeking information to fix a problem in the business,” “the user desires to understand the causes of the problem in the business,” “the user wants to understand the implications of theft on the business,” “the user desires to end the theft in the business,” “the user wants to maintain a good rapport with the employees,” “the user wants to know what is the most pertinent problem in the company,” “the user is seeking to find information regarding partnering with another company,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, a type of business that the user owns, issues that have arisen with respect to the user's business, implications for the user's business, hiring practices of the user, business practices of the user, security measures the user has taken, rules and/or procedures in the user's business, contractual obligations in the user's business, etc., and may include any information available on social media, the Internet, data files, records, etc.

A communication unit may also then access the third information 30 in order to gather information related to the query. As such, a communication unit may access user profiles, social media, external servers, data, websites, or any other type of information related to reasons why people steal, statistics regarding theft, implications of theft on various businesses, methods of curtailing theft, information regarding the various employees in the user's business, etc. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine how the user can understand why the employees are stealing, and how to fix this problem.

Specifically, a processor may run simulations using the first information 10 (i.e., information related to the user) with respect to various different solutions to dissuade employees from stealing and/or rewarding employees when they do not steal, which would be part of the third information 30 (i.e., the domain information), in the context of the second information 20. Each simulation is scored and/or rated, and the best scored and/or rated simulation is interpreted to include the best solution. As such, a display unit may display the best result of the simulation, which will be the best solution to the user's problem of employee theft within the business.

Also, a display unit may display a portion of the results of the simulation, such as the top 10 simulation results, and create a list of potential best solutions to end the employee theft in the business.

The system 1000 may also identify which information decision makers most urgently need to know in order to inform their own understanding of the situation and react in an intelligent manner.

Alternatively, a device may access the above information directly, or may acquire it via a communication unit, and then may process the information using a processor in order to determine at least one solution to end the employee theft within the business. Subsequently, a display unit of a device may display a list of potential best solutions to end the employee theft in the business.

As such, the user's generalized query of “my employees are stealing from the company” is answered by the system 1000, such that the system 1000 outputs a specific answer that is tailored to the user and the user's company/business.

### Query—What is the Likelihood of My Idea's or Venture's Success?

The user may use an input unit to input a generalized query, such as “what is the likelihood of my idea's or venture's success?” The query may then be sent from a device. However, this particular query is extremely general, and the system 1000 may output a secondary question after analyzing the query, such as “what is your particular idea or venture?” If this is the case, then the user may input a secondary query and/or response with additional information, such as “I want to open an ice cream shop in Taipei, Taiwan.” This is only an example, and any idea or venture may be input by the user.

A processor may interpret the query as the second information 20 in order to gather information that may specifically define the query. As such, the second information 20, in this case, may include information including, but not limited to, “the user wants to open a business,” “the user wants to open up a specific business to sell ice cream,” “the user wants the business to be located in Taipei, Taiwan,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, a personality type of the user, an education level of the user, implications on the user's future of opening a business, implications on a user's happiness of owning a business vs. working for someone else, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to ice cream shops, information regarding Taipei, Taiwan, successes of businesses in Taipei, Taiwan, real-estate information, etc. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine the potential of success the user would experience if the user opened an ice cream shop in Taipei, Taiwan.

Specifically, a processor may run simulations using the first information 10 (i.e., information related to the user) with respect to various different scenarios regarding problems and positive outcomes that would arise if the user opened up an ice cream shop in Taipei, Taiwan, which would be part of the third information 30 (i.e., the domain information), in the context of the second information 20. Each simulation is scored and/or rated, and the best scored and/or rated simulation is interpreted to include the best match for the user. As such, a display unit may display the best result of the simulation, which will be the best-case scenario for the user of opening up an ice cream shop in Taipei, Taiwan.

Also, a display unit may display a portion of the results of the simulation, such as the top 10 simulation results, and create a list of potential best-case scenarios for the user of opening up an ice cream shop in Taipei, Taiwan.

Alternatively, a device may access the above information directly, or may acquire it via a communication unit, and then may process the information using a processor in order to determine the best-case scenario for the user of opening up an ice cream shop in Taipei, Taiwan. Subsequently, a display unit of a device may display a list of potential best-case scenarios for the user of opening up an ice cream shop in Taipei, Taiwan.

As such, the user's generalized question of “what is the potential of success for opening up an ice cream shop in Taipei, Taiwan?” is answered by the system 1000, such that the system 1000 outputs a specific answer that is tailored to the user.

Alternatively, the user may initially pose a similar question, such as “what would potential roadblocks be with regard to opening up an ice cream shop in Taipei, Taiwan?” (i.e., “what are potential roadblocks with regard to my idea or venture?”). Accordingly, the same and/or similar types of above information and/or processes may be used by the system 1000 to answer this question, but may include alternative first information 10, second information 20, and third information 30 that is tailored to “roadblocks” instead of “successes.”

Query—What Video should I Watch on the Internet?

The user may use an input unit to input a generalized query, such as “what video should I watch on the Internet?” The query may then be sent from a device.

A processor may interpret the query as the second information 20 in order to gather information that may specifically define the query. As such, the second information 20, in this case, may include information including, but not limited to, “the user is seeking video to watch,” “the user is seeking a video that is available on the Internet,” “the user is seeking a video that will be enjoyable for the user,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, feelings people experience when watching different types of media (e.g., adventure, comedies, documentaries, dramas, horror, romance, thrillers, etc.), types of videos or genres that the user prefers, popular videos on the Internet, videos preferred by people with characteristics or past-experiences similar to the user, political preferences of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to videos that are available on the Internet, best-rated videos, videos rated by demographic, videos preferred by various types of people, etc. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what videos the user should watch.

Specifically, a processor may run simulations using the first information 10 (i.e., information related to the user) with respect to various different videos and their effects on the user, which would be part of the third information 30 (i.e., the domain information), in the context of the second information 20. Each simulation is scored and/or rated, and the best scored and/or rated simulation is interpreted to include the best matched video(s) for the user. As such, a display unit may display the best result of the simulation, which will be the videos that would have the most positive impact on the user.

Also, a display unit may display a portion of the results of the simulation, such as the top 10 simulation results, and create a list of potential best videos for the user to view.

Alternatively, a device may access the above information directly, or may acquire it via a communication unit, and then may process the information using a processor in order to determine which videos the user should watch. Subsequently, a display unit of a device may display a list of potential best videos for the user to view.

As such, the user's generalized question of “what video should I watch on the Internet?” is answered by the system 1000, such that the system 1000 outputs a specific answer that is tailored to the user.

Query—What Song should I Listen to?

The user may use an input unit to input a generalized query, such as “what song should I listen to?” The query may then be sent from a device.

A processor may interpret the query as the second information 20 in order to gather information that may specifically define the query. As such, the second information 20, in this case, may include information including, but not limited to, “the user desires to listen to music,” “the user is seeking particular song,” “the user is seeking a song that will be enjoyable for the user,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, feelings people experience when listening to different types of music (e.g., alternative, blues, classical, classic rock, jazz, modern rock, rap, R&B, soul, techno, etc.), types of music that the user prefers, music preferred by various types of people, ethnic background of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to music, such as databases of songs, lists of top-rated music, lists of popular songs, news articles about bands, etc. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what songs the user should listen to.

Specifically, a processor may run simulations using the first information 10 (i.e., information related to the user) with respect to various different songs and their effects on the user, which would be part of the third information 30 (i.e., the domain information), in the context of the second information 20. Each simulation is scored and/or rated, and the best scored and/or rated simulation is interpreted to include the best matched song(s) for the user. As such, a display unit may display the best result of the simulation, which will be the songs that would have the most positive impact on the user.

Also, a display unit may display a portion of the results of the simulation, such as the top 10 simulation results, and create a list of potential best songs for the user to view.

Alternatively, a device may access the above information directly, or may acquire it via a communication unit, and then may process the information using a processor in order to determine which songs the user should listen to. Subsequently, a display unit of a device may display a list of potential best songs for the user to view.

As such, the user's generalized question of “what songs should I listen to?” is answered by the system 1000, such that the system 1000 outputs a specific answer that is tailored to the user.

Query—What Classes should I Take at a University?

The user may use an input unit to input a generalized query, such as “what classes should I take at a university?” The query may then be sent from a device.

A processor may interpret the query as the second information 20 in order to gather information that may specifically define the query. As such, the second information 20, in this case, may include information including, but not limited to, “the user is enrolled in a university,” “the user wants to take classes at a university,” “the user desires to know which classes are required for the user,” “the user desires to know which classes will be most interesting for the user,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications for the user's future regarding taking part in a particular class or academic subject, a personality type of the user, a potential future profession of the user, hobbies of the user, emotional characteristics of the user, overall professional goals of the user, social goals of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to classes offered at particular universities, professional successes of individuals who have taken various courses, statistics regarding job placement with respect to courses taken in college, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine which classes the user should take.

Specifically, a processor may run simulations using the first information 10 (i.e., information related to the user) with respect to various different combinations of classes the user could potentially take user, which would be part of the third information 30 (i.e., the domain information), in the context of the second information 20. Each simulation is scored and/or rated, and the best scored and/or rated simulation is interpreted to include the best set of classes for the user. As such, a display unit may display the best result of the simulation, which will be the classes that the user should take at a particular University.

Also, a display unit may display a portion of the results of the simulation, such as the top 10 simulation results, and create a list of potential best-matched classes for the user.

Alternatively, a device may access the above information directly, or may acquire it via a communication unit, and then may process the information using a processor in order to determine which classes the user should take. Subsequently, a display unit of a device may display a list of potential best-matched classes for the user.

The same and/or similar types of above information and/or processes may be used to answer similar questions/queries, including, but not limited to, “which college should I attend?”, “which business conference should I attend?”, etc. However, the differences between these questions may be controlled by the second information 20, which would define each query, and include specific information including, but not limited to, “the user wishes to attend a college that will bring the user the most success,” “user wants to maximize the user's benefits by attending proper conferences,” etc.

As such, the user's generalized question of “what classes should I take at a university?” is answered by the system 1000, such that the system 1000 outputs a specific answer that is tailored to the user.

Query—which Stock should I Invest in?

The user may use an input unit to input a generalized query, such as “which stock should I invest in?” The query may then be sent from a device.

A processor may interpret the query as the second information 20 in order to gather information that may specifically define the query. As such, the second information 20, in this case, may include information including, but not limited to, “the user wants to make an investment,” “the user desires to invest in a stock,” “the user desires to make money from an investment,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, a personality type of the user, implications on the user's future if the user were to lose money and/or make money, a profession of the user, earning potential of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to the stock market, stock market trends, statistical fluctuations of the stock market, business profiles, technological advances, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine which stock, if any, the user should invest in.

Specifically, a processor may run simulations using the first information 10 (i.e., information related to the user) with respect to various different potential stocks that would be suitable for the user to invest in, which would be part of the third information 30 (i.e., the domain information), in the context of the second information 20. Each simulation is scored and/or rated, and the best scored and/or rated simulation is interpreted to include the best matched stock (or stocks) for the user. As such, a display unit may display the best result of the simulation, which will be the stock (or stocks) which would be most suitable for the user.

Also, a display unit may display a portion of the results of the simulation, such as the top 10 simulation results, and create a list of potential best-matched stocks for the user.

Alternatively, a device may access the above information directly, or may acquire it via a communication unit, and then may process the information using a processor in order to determine which stock (or stocks) the user should invest in. Subsequently, a display unit of a device may display a list of potential best-matched stock (or stocks) for the user.

The same and/or similar types of above information and/or processes may be used to answer similar questions/queries, including, but not limited to, “what are the best investment opportunities available for me for the largest return?”, “what market should I enter?”, “what market should I expand my business into?”, “what business should I invest in?”, etc. However, the differences between these questions may be controlled by the second information 20, which would define each query, and include specific information including, but not limited to, “the user desires to make investments that have the greatest return with least amount of risk,” “user wants to enter into a market that will be lucrative,” “the user wants to expand the user's business by entering into a new market,” etc.

As such, the user's generalized question of “which stock should I invest in?” is answered by the system 1000, such that the system 1000 outputs a specific answer that is tailored to the user.

Query—Find Me the Lawyer that I Need for Patents

The user may use an input unit to input a generalized query, such as “find me the lawyer that I need for patents.” The query may then be sent from a device.

If this query were typed into a regular search engine, then all of the patent attorneys closest to the user would most likely be returned as options. However, these patent attorneys may not have the qualifications or skill-sets that the user requires. The system 1000 solves this problem by tailoring the returned patent attorney(s) to the user's specific needs.

A processor may interpret the query as the second information 20 in order to gather information that may specifically define the query. As such, the second information 20, in this case, may include information including, but not limited to, “the user is seeking a patent attorney,” “the user is seeking a patent attorney with particular qualifications and/or skill-sets,” “the user requires a qualified patent attorney at a reasonable cost,” etc. The system 1000 may also prompt the user in this case to describe the type of technology that the user is seeking to protect, in order to further substantiate and/or delineate the skills required by a particular patent attorney and to further tailor the answer to the user's needs.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, types of technology utilized and/or invented by the user, implications that various personality types may have on the user's health and well-being, an education level of the user, a profession of the user (scientist, doctor, lawyer, actor, singer, dancer, accountant, etc.), hobbies of the user (rock-climbing, karaoke, cooking, skydiving, scuba diving, spelunking, gambling, fantasy football, etc.), emotional characteristics of the user, professional goals of the user, social goals of the user, a daily schedule/itinerary of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to potential patent attorneys and/or law firms available to the user, technologies available in society, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine which patent attorney the user should hire.

Specifically, a processor may run simulations using the first information 10 (i.e., information related to the user) with respect to various different potential patent attorneys available to the user and the effects that the different patent attorneys would have on the user and/or the user's technology, which would be part of the third information 30 (i.e., the domain information), in the context of the second information 20. Each simulation is scored and/or rated, and the best scored and/or rated simulation is interpreted to include the best matched patent attorney for the user. As such, a display unit may display the best result of the simulation, which will be the patent attorney that the user should hire.

Also, a display unit may display a portion of the results of the simulation, such as the top 10 simulation results, and create a list of potential best-matched patent attorneys for the user.

Alternatively, a device may access the above information directly, or may acquire it via a communication unit, and then may process the information using a processor in order to determine which patent attorney the user should hire. Subsequently, a display unit of a device may display a list of potential best-matched patent attorneys for the user.

The same and/or similar types of above information and/or processes may be used to answer similar questions/queries, including, but not limited to, “who should I hire?”, “what marketing techniques should I use in my business?”, “who should I recruit,” “what corporate moves should I make?”, etc. However, the differences between these questions may be controlled by the second information 20, which would define each query, and include specific information including, but not limited to, “the user wishes to employ a new person,” “the user desires to increase business recognition in the marketplace,” “the user wants to persuade a person to work at the user's company,” “the user desires to increase business revenue/success in the near future,” etc.

As such, the user's generalized question of “find me the lawyer that I need for patents?” is answered by the system 1000, such that the system 1000 outputs a specific answer that is tailored to the user.

The same and/or similar types of above information and/or processes may be used to answer similar questions/queries related to hiring any types of professionals required by the user, including, but not limited to, “which plumber should I hire”, “which roofer should I fire,” etc. However, the differences between these questions may be controlled by the second information 20, which would define each query, and include specific information including, but not limited to, “the user needs to have his toilet fixed at a reasonable price,” “the user wants to fix a broken chimney,” etc.

Query—What Insurance should I Buy?

The user may use an input unit to input a generalized query, such as “what insurance should I buy?” The query may then optionally be sent from a device.

A processor may interpret the query as the second information 20 in order to gather information that may specifically define the query. As such, the second information 20, in this case, may include information including, but not limited to, “the user requires insurance,” “the user wants to protect the user's loved-ones from debt after the user's death and/or incapacitation,” “the user wants protection from unexpected accidents and/or occurrences,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, effects that insurance will have on the user's future, a marital status of the user (e.g., married, separated, divorced, single, etc.), a child status of the user (i.e., how many children, if any, does the user have), a personality type of the user, an education level of the user, a profession of the user, personal information regarding the user (e.g., height, weight, gender, health status, criminal records, etc.), other financial responsibilities of the user, a salary of the user, current insurance owned by the user, etc., but is not limited to the above information related to the user, and may include any information available on social media, the Internet, data files, records, online-insurance databases, etc.

A communication unit may also then access the third information 30 in order to gather information related to the query. As such, a communication unit may access insurance company databases, online Internet databases, insurance ranking databases, blogs, social media, external servers, data, websites, or any other type of information related to insurance, and may find insurance policies customized to the user's needs and desires. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what type of insurance the user needs and/or which would be beneficial for the user.

Specifically, a processor may run simulations using the first information 10 (i.e., information related to the user) with respect to various different potential insurance options available for the user, which would be part of the third information 30 (i.e., the domain information), in the context of the second information 20. Each simulation is scored and/or rated, and the best scored and/or rated simulation is interpreted to include the best matched insurance(s) for the user. As such, a display unit may display the best result of the simulation, which will be the insurance(s) that the user should purchase.

Then, a display unit may display the results of the processing, and create a list of potential best-matched insurance for the user. A processor may also categorize the insurance by type (e.g., business, medical, life, homeowner's, car, etc.), to allow the display unit 120 to display the insurance customized for the user by type.

Alternatively, a device may access the above information directly, or may acquire it via a communication unit, and then may process the information using a processor in order to determine what types of insurance the user should purchase. Subsequently, a display unit of a device may display a list of potential best-matched insurance for the user.

As such, the user's generalized question of “what insurance should I buy?” is answered by the system 1000.

Additionally, although the system 1000 is designed to allow the user to simply input the single question of “what insurance should I buy,” and then output a customized answer for the user, the system 1000 may display one or two questions on a display unit of a device to further narrow-down options for the user. For example, the system 1000 may display the questions “what type of insurance do you need?”, in order to allow the user to delineate with even more accuracy, the types of insurance (e.g., business, medical, life, homeowner's, car, etc.) needed/desired by the user.

Query—which Restaurant should I Eat at?

The user may use an input unit to input a generalized query, such as “which restaurant should I eat at?” The query may then be sent from a device.

A processor may interpret the query as the second information 20 in order to gather information that may specifically define the query. As such, the second information 20, in this case, may include information including, but not limited to, “the user is seeking a place to eat,” “the user wants to eat a meal that is desirable to the user,” “the user wants an affordable meal”, etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications regarding various foods on the user, medical conditions of the user, a dietary preference of the user (kosher, lactose intolerant, omnivorous, vegan, vegetarian, etc.), monetary constraints of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to potential restaurants that serve food desirable for the user, ratings of various restaurants, news articles related to different restaurants, consequences of different types of foods, etc. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine in which restaurant the user should choose to eat.

Specifically, a processor may run simulations using the first information 10 (i.e., information related to the user) with respect to effects that various different potential restaurants would have on the user, which would be part of the third information 30 (i.e., the domain information), in the context of the second information 20. Each simulation is scored and/or rated, and the best scored and/or rated simulation is interpreted to include the best matched restaurant for the user. As such, a display unit may display the best result of the simulation, which will be the restaurant in which the user should choose to eat a meal.

Also, a display unit may display a portion of the results of the simulation, such as the top 10 simulation results, and create a list of potential best-matched restaurants for the user.

Alternatively, a device may access the above information directly, or may acquire it via a communication unit, and then may process the information using a processor in order to determine the restaurant in which the user should choose to eat a meal. Subsequently, a display unit of a device may display a list of potential best-matched restaurants for the user.

The same and/or similar types of above information and/or processes may be used to answer similar questions/queries, including, but not limited to, “what foods should I eat to maintain my diet goals?”, “how do I maintain a particular diet without side effects,” “what should I eat today?”, etc. However, the differences between these questions may be controlled by the second information 20, which would define each query, and include specific information including, but not limited to, “the user wishes to eat food that helps the user lose weight or maintain the user's weight,” “the user wants to know what is the best food choice for the user's next meal,” etc.

As such, the user's generalized question of “which restaurant should I eat at?” is answered by the system 1000, such that the system 1000 outputs a specific answer that is tailored to the user.

Query—What Types of Electronics should I Buy?

The user may use an input unit to input a generalized query, such as “what types of electronics should I buy?” The query may then be sent from a device.

A processor may interpret the query as the second information 20 in order to gather information that may specifically define the query. As such, the second information 20, in this case, may include information including, but not limited to, “the user is seeking new technological products,” “the user is seeking an automated solution to a problem,” “the user desires convenience,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications of various technologies on the user's life, a marital status of the user (e.g., married, separated, divorced, single, etc.), a child status of the user (i.e., how many children, if any, does the user have), a personality type of the user, an education level of the user, a profession of the user, brand names preferred by the user, a salary of the user, previous purchases of electronics from various stores/websites/etc., current electronics owned by the user, outdated electronics owned by the user, etc., but is not limited to the above information related to the user, and may include any information available on social media, the Internet, data files, records, online-store databases, etc.

A communication unit may also then access the third information 30 in order to gather information related to the query. As such, a communication unit may access user profiles, social media, external servers, data, websites, or any other type of information related to electronics and/or technological devices, ratings of different electronics, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine who the electronics that the user should purchase.

Specifically, a processor may run simulations using the first information 10 (i.e., information related to the user) with respect to the effects of various different potential electronics on the user, which would be part of the third information 30 (i.e., the domain information), in the context of the second information 20. Each simulation is scored and/or rated, and the best scored and/or rated simulation is interpreted to include the best matched electronics for the user. As such, a display unit may display the best result of the simulation, which will be the electronics that the user should purchase.

Also, a display unit may display a portion of the results of the simulation, such as the top 10 simulation results, and create a list of potential best-matched electronics for the user.

A processor may also categorize the electronics by type (e.g., televisions, computers, mobile devices, etc.), to allow the display unit 120 to display the electronics customized for the user by type.

Alternatively, a device may access the above information directly, or may acquire it via a communication unit, and then may process the information using a processor in order to determine what types of electronics the user should purchase. Subsequently, a display unit of a device may display a list of potential best-matched electronics for the user.

As such, the user's generalized question of “what types of electronics should I buy?” is answered by the system 1000.

Additionally, although the system 1000 is designed to allow the user to simply input the single question of “what types of electronics should I buy,” and then output a customized answer for the user, the system 1000 may display one or two questions on a display unit of a device to further narrow-down options for the user. For example, the system 1000 may display the questions “what type of product do you need?”, in order to delineate with even more accuracy, the types of electronics (e.g., televisions, computers, mobile devices, etc.) needed/desired by the user.

Furthermore, the same and/or similar types of above information and/or processes may be used to answer similar questions/queries, including, but not limited to, “what products should I buy?”, “what phone plan should I buy?”, “what art should I buy?”, “should I buy a new object or keep the old one?”, etc. However, the differences between these questions may be controlled by the second information 20, which would define each query, and include specific information including, but not limited to, “the user wishes to buy particular products to increase the user's happiness,” “the user wants to know what phone plan best suits the user's needs,” “the user wants to purchase artwork to put the user in a certain mood,” “the user wants to know the benefits and drawbacks of purchasing a new item versus keep the old item,” etc.

### Query—What is the Best Medical Course of Action for My Condition?

The user may use an input unit to input a generalized query, such as “what is the best medical course of action for my condition?” The query may then be sent from a device.

A processor may interpret the query as the second information 20 in order to gather information that may specifically define the query. As such, the second information 20, in this case, may include information including, but not limited to, “the user is has a particular medical condition,” “the user's medical condition requires medical care,” “the user desires to become healthy,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, effects that certain medication may have on the user, effects that certain medical procedures may have on the user, implications of medicine or medical procedures on a gender of the user, a medical history of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to various types of illnesses and/or medical conditions, various different types of medication and/or medical procedures, statistics involving success of various medication and/or medical procedures, medical journals, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what type of medication the user should take and/or what type of medical procedure(s) the user should undergo.

Specifically, a processor may run simulations using the first information 10 (i.e., information related to the user) with respect to effects of various different medication and/or medical procedures on the medical condition of the user, which would be part of the third information 30 (i.e., the domain information), in the context of the second information 20. Each simulation is scored and/or rated, and the best scored and/or rated simulation is interpreted to include the best match of medication and/or medical procedure for the user. As such, a display unit may display the best result of the simulation, which type of medication the user should take and/or the medical procedure(s) the user should undergo.

Also, a display unit may display a portion of the results of the simulation, such as the top 10 simulation results, and create a list of potential best-matched medication or medical procedure(s) for the user.

Alternatively, a device may access the above information directly, or may acquire it via a communication unit, and then may process the information using a processor in order to determine which type of medication the user should take and/or the medical procedure(s) the user should undergo. Subsequently, a display unit of a device may display a list of potential best-matched which type of medication the user should take and/or the medical procedure(s) the user should undergo.

As such, the user's generalized question of “what is the best medical course of action for my condition?” is answered by the system 1000, such that the system 1000 outputs a specific answer that is tailored to the user.

Query—What should I Wear Today?

The user may use an input unit to input a generalized query, such as “what should I wear today?” The query may then be sent from a device.

A processor may interpret the query as the second information 20 in order to gather information that may specifically define the query. As such, the second information 20, in this case, may include information including, but not limited to, “the user wants to know what type of outfit to wear,” “the user is seeking advice on the best outfit for the event that the user will be attending on a particular day,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications of various attire on how the user may be perceived by others, information regarding clothing the user possesses, effects on the user related to purchasing new clothes, a personality type of the user, an education level of the user, a profession of the user (scientist, doctor, lawyer, actor, singer, dancer, accountant, etc.), hobbies of the user (rock-climbing, karaoke, cooking, skydiving, scuba diving, spelunking, gambling, fantasy football, etc.), emotional characteristics of the user, professional goals of the user, a schedule of the user, and social goals of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to current styles of clothing, proper ways to dress in various situations, effects of clothing and/or colors on people, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what the user should wear.

Specifically, a processor may run simulations using the first information 10 (i.e., information related to the user) with respect to effects of various clothing on the user with regard to various events the user will experience in a particular day, which would be part of the third information 30 (i.e., the domain information), in the context of the second information 20. Each simulation is scored and/or rated, and the best scored and/or rated simulation is interpreted to include the best clothing options for the user. As such, a display unit may display the best result of the simulation, which will be the clothing that the user should wear.

Also, a display unit may display a portion of the results of the simulation, such as the top 10 simulation results, and create a list of potential best-matched clothing for the user.

Alternatively, a device may access the above information directly, or may acquire it via a communication unit, and then may process the information using a processor in order to determine what clothing the user should wear. Subsequently, a display unit of a device may display a list of potential best-matched clothing for the user.

The same and/or similar types of above information and/or processes may be used to answer similar questions/queries, including, but not limited to, “what hairstyle should I have?”, etc. However, the differences between these questions may be controlled by the second information 20, which would define each query, and include specific information including, but not limited to, “the user wishes to have a particular hairstyle that will be appropriate for the user's profession,” etc.

As such, the user's generalized question of “what should I wear today?” is answered by the system 1000, such that the system 1000 outputs a specific answer that is tailored to the user.

Query—where should I go on Vacation?

The user may use an input unit to input a generalized query, such as “where should I go on vacation?” The query may then be sent from a device.

A processor may interpret the query as the second information 20 in order to gather information that may specifically define the query. As such, the second information 20, in this case, may include information including, but not limited to, “the user desires to take a break from work,” “the user is seeking a location to travel to,” “the user wants to know the best place that the user can rest,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, feelings the user would experience in various locations, weather/climate preferences of the user, effects of different vacation spots on the user's well-being, a personality type of the user, a dietary preference of the user, education level of the user, a profession of the user (scientist, doctor, lawyer, actor, singer, dancer, accountant, etc.), hobbies of the user (rock-climbing, karaoke, cooking, skydiving, scuba diving, skiing, spelunking, gambling, fantasy football, etc.), emotional characteristics of the user, social goals of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to potential mates for the user, and may find information related to potential mates for the user that is similar to the above information gathered about the user. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine where the user should go on vacation.

Specifically, a processor may run simulations using the first information 10 (i.e., information related to the user) with respect to various different potential vacation destinations that the user could go to and the different effects that these locations could have on the user, which would be part of the third information 30 (i.e., the domain information), in the context of the second information 20. Each simulation is scored and/or rated, and the best scored and/or rated simulation is interpreted to include the best vacation destination match for the user. As such, a display unit may display the best result of the simulation, which will be the place that the user should go on vacation.

Also, a display unit may display a portion of the results of the simulation, such as the top 10 simulation results, and create a list of potential best-matched vacation destinations for the user.

Alternatively, a device may access the above information directly, or may acquire it via a communication unit, and then may process the information using a processor in order to determine where the user should go on vacation. Subsequently, a display unit of a device may display a list of potential best-matched vacation destinations for the user.

The same and/or similar types of above information and/or processes may be used to answer similar questions/queries, including, but not limited to, “where should I go for happy hour?”, “where should I travel to?”, “where should I hold my business meeting?”, “where should I take my group for fun experiences?”, etc. However, the differences between these questions may be controlled by the second information 20, which would define each query, and include specific information including, but not limited to, “the user wishes to go to a bar or pub after work,” “the user desires to go somewhere on a trip,” “the user needs to set up a business meeting at a particular location,” “the user wants to take a group of people on an enjoyable excursion,” etc.

As such, the user's generalized question of “where should I go on vacation?” is answered by the system 1000, such that the system 1000 outputs a specific answer that is tailored to the user.

Query—What Strategies or Policies should I Adopt in My Business?

The user may use an input unit to input a generalized query, such as “what strategies or policies should I adopt in my business?” The query may then be sent from a device.

A processor may interpret the query as the second information 20 in order to gather information that may specifically define the query. As such, the second information 20, in this case, may include information including, but not limited to, “the user owns a business,” “the user desires to improve the user's business,” “the user wants to adopt a new strategy or policy that will improve the user's business,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, the type of business the user owns, a personality type of the user, an education level of the user, a profession of the user (scientist, doctor, lawyer, actor, singer, dancer, accountant, etc.), emotional characteristics of the user, professional goals of the user, social goals of the user, leadership principles of the user, business practices of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to various types of business strategies and policies available in the world, effects of various types of business strategies and policies available in the world, statistics of effects of changing business practices, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine which strategies or policies the user should implement in the user's business.

Specifically, a processor may run simulations using the first information 10 (i.e., information related to the user) with respect to effects of various different strategies and/or policies that the user could potentially implement in the user's business, which would be part of the third information 30 (i.e., the domain information), in the context of the second information 20. Each simulation is scored and/or rated, and the best scored and/or rated simulation is interpreted to include the best business strategies and/or policies for the user. As such, a display unit may display the best result of the simulation, which will be the strategies or policies the user should implement in the user's business.

Also, a display unit may display a portion of the results of the simulation, such as the top 10 simulation results, and create a list of potential best-matched strategies and/or policies for the user's business.

Alternatively, a device may access the above information directly, or may acquire it via a communication unit, and then may process the information using a processor in order to determine which strategies and/or policies for the user's business that the user should implement. Subsequently, a display unit of a device may display a list of potential best-matched strategies and/or policies for the user's business.

As such, the user's generalized question of “what strategies or policies should I adopt in my business?” is answered by the system 1000, such that the system 1000 outputs a specific answer that is tailored to the user.

Query—how should I Decorate My Home?

The user may use an input unit to input a generalized query, such as “how should I decorate my home?” The query may then be sent from a device.

A processor may interpret the query as the second information 20 in order to gather information that may specifically define the query. As such, the second information 20, in this case, may include information including, but not limited to, “the wants to change the aesthetic appearance of the user's home,” “the user has to live with whatever changes occur within the user's home,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, effects of various types of decorations/furniture/colors on the user, a personality type of the user, emotional characteristics of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to various types of decorations/furniture/paints available to the user, statistics involving valuation of houses, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine how the user should decorate the user's house.

Specifically, a processor may run simulations using the first information 10 (i.e., information related to the user) with respect to effects of various different housing decoration on the user and the value of the house, which would be part of the third information 30 (i.e., the domain information), in the context of the second information 20. Each simulation is scored and/or rated, and the best scored and/or rated simulation is interpreted to include the best match for the user. As such, a display unit may display the best result of the simulation, which will be the way that the user should decorate the user's house.

Also, a display unit may display a portion of the results of the simulation, such as the top 10 simulation results, and create a list of potential best-matched housing decorations for the user.

Alternatively, a device may access the above information directly, or may acquire it via a communication unit, and then may process the information using a processor in order to determine how the user should decorate the user's house. Subsequently, a display unit of a device may display a list of potential best-matched housing decorations for the user.

As such, the user's generalized question of “how should I decorate my home?” is answered by the system 1000, such that the system 1000 outputs a specific answer that is tailored to the user.

Query—What Movie should I See?

The user may use an input unit to input a generalized query, such as “what movie should I see?” The query may then be sent from a device.

A processor may interpret the query as the second information 20 in order to gather information that may specifically define the query. As such, the second information 20, in this case, may include information including, but not limited to, “the user wants to see a movie,” “the user is seeking a particular movie to satisfy the user's desire to be entertained,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, effects particular movie genres may have on the user, a current state of the user's psyche, previous movies the user has seen, effects on the user of previous movies the user has seen, implications of various types of movies with regard to a gender of the user, a personality type of the user, a political preference of the user, emotional characteristics of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to potential movies available for the user to view, ratings of various movies, the current cultural trends regarding films, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what movie the user should watch.

Specifically, a processor may run simulations using the first information 10 (i.e., information related to the user) with respect to effects that various different potential movies would have on the user, which would be part of the third information 30 (i.e., the domain information), in the context of the second information 20. Each simulation is scored and/or rated, and the best scored and/or rated simulation is interpreted to include the best matched movie(s) for the user. As such, a display unit may display the best result of the simulation, which will be the movie that the user should watch.

Also, a display unit may display a portion of the results of the simulation, such as the top 10 simulation results, and create a list of potential best-matched movies for the user.

Alternatively, a device may access the above information directly, or may acquire it via a communication unit, and then may process the information using a processor in order to determine which movie the user should watch. Subsequently, a display unit of a device may display a list of potential best-matched movies for the user.

The same and/or similar types of above information and/or processes may be used to answer similar questions/queries, including, but not limited to, “what drink should I order at the bar?”, “what whiskey should I drink?”, etc. However, the differences between these questions may be controlled by the second information 20, which would define each query, and include specific information including, but not limited to, “the user desires a particular type of beverage,” “the user specifically wants a whiskey that complements his/her palate,” etc.

As such, the user's generalized question of “what movie should I see?” is answered by the system 1000, such that the system 1000 outputs a specific answer that is tailored to the user.

Query—What should I do for My Spouse?

The user may use an input unit to input a generalized query, such as “what should I do for my spouse?” The query may then be sent from a device.

A processor may interpret the query as the second information 20 in order to gather information that may specifically define the query. As such, the second information 20, in this case, may include information including, but not limited to, “the user wants to do something for the user's spouse,” “the user wants to make the user's spouse happy,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications regarding making the user's spouse happy/sad, a personality type of the user, emotional characteristics of the user, past things that the user has done for the user's spouse, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to ways to make a spouse happy, characteristics and/or personality type of the user's spouse, various types of things that people could potentially do for each other to produce positive emotions, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what the user should do for the user's spouse.

Specifically, a processor may run simulations using the first information 10 (i.e., information related to the user) with respect to effects of doing various different things for the user's spouse, which would be part of the third information 30 (i.e., the domain information), in the context of the second information 20. Each simulation is scored and/or rated, and the best scored and/or rated simulation is interpreted to include the best thing(s) the user should do for the user's spouse. As such, a display unit may display the best result of the simulation, which will be the best thing the user could possibly do for the user's spouse.

Also, a display unit may display a portion of the results of the simulation, such as the top 10 simulation results, and create a list of various things that the user could do for the user's spouse to make the spouse happy.

Alternatively, a device may access the above information directly, or may acquire it via a communication unit, and then may process the information using a processor in order to determine what the user should do for the user's spouse. Subsequently, a display unit of a device may display a list of various things that the user could do for the user's spouse to make the spouse happy.

As such, the user's generalized question of “what should I do for my spouse?” is answered by the system 1000, such that the system 1000 outputs a specific answer that is tailored to the user.

Query—how should I Spend My Money?

The user may use an input unit to input a generalized query, such as “how should I spend my money?” The query may then be sent from a device.

A processor may interpret the query as the second information 20 in order to gather information that may specifically define the query. As such, the second information 20, in this case, may include information including, but not limited to, “the user wants to do spend money,” “the user wants to maximize the use of his/her money in order to achieve happiness,” “the user wants to maximize the use of his/her money in order to make the most positive impact on the world,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, implications regarding spending money on various things, effects of losing money versus saving money, the current state of the world, moral considerations with regard to the user's personality/personal preferences, past things that the user has done spent money on, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to ways to make the user happy, characteristics and/or personality type of the user, various types of things that people could spend money on to produce positive emotions, various types of things that people could spend money on to make the world a better place, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine how the user should spend his/her money.

Specifically, a processor may run simulations using the first information 10 (i.e., information related to the user) with respect to effects of spending money on various different things, which would be part of the third information 30 (i.e., the domain information), in the context of the second information 20. Each simulation is scored and/or rated, and the best scored and/or rated simulation is interpreted to include the best way(s) the user should spend his/her money. As such, a display unit may display the best result of the simulation, which will be the best thing the user could spend his/her money on.

Also, a display unit may display a portion of the results of the simulation, such as the top 10 simulation results, and create a list of various things that the user could spend his/her money on to maximize happiness and/or world harmony.

Alternatively, a device may access the above information directly, or may acquire it via a communication unit, and then may process the information using a processor in order to determine what the user should do for the user's spouse. Subsequently, a display unit of a device may display a list of various things that the user could spend his/her money on to maximize happiness and/or world harmony.

The same and/or similar types of above information and/or processes may be used to answer similar questions/queries, including, but not limited to, “what charity should I contribute to?”, “what is the best way to maximize profits?”, “where and when should I invest my money?”, etc.

As such, the user's generalized question of “how should I spend my money?” is answered by the system 1000, such that the system 1000 outputs a specific answer that is tailored to the user.

### Query—What Should I Do With My Life?

The user may use an input unit to input a generalized query, such as “what should I do with my life?” The query may then be sent from a device.

A processor may interpret the query as the second information 20 in order to gather information that may specifically define the query. As such, the second information 20, in this case, may include information including, but not limited to, “the user wants to know what the best course is for the user's life,” “the user most likely wants to choose a path that leads to happiness,” “the user needs to understand the user's own personality traits,” “the user may not consciously be aware of what is best for the user's future,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may include the general user information 11 and/or idiosyncratic user information 12. Thus, the first information 10 may collectively include, but is not limited to, effects that the user's actions have had on others, the user's strongest qualities, information related to the user's talents and drawbacks, a personality type of the user, emotional characteristics of the user, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to potential paths for the user's future, various job opportunities, market trends, various paths to success, various paths to happiness, etc., but is not limited thereto. A storage unit may store all of the aforementioned information, i.e., the third information 30, for present and future access.

A processor may then process the first information 10 (i.e., information related to the user) together with the third information 30 (i.e., the domain information) in the context of the second information 20 (i.e., information defining the query), in order to determine what movie the user should do with his/her life.

Specifically, a processor may run simulations using the first information 10 (i.e., information related to the user) with respect to effects that various different potential life paths of the user, which would be part of the third information 30 (i.e., the domain information), in the context of the second information 20. Each simulation is scored and/or rated, and the best scored and/or rated simulation is interpreted to include the best matched life path(s) for the user. As such, a display unit may display the best result of the simulation, which will be the path that the user should follow in his/her life.

Also, a display unit may display a portion of the results of the simulation, such as the top 10 simulation results, and create a list of potential best-matched life paths for the user.

Alternatively, a device may access the above information directly, or may acquire it via a communication unit, and then may process the information using a processor in order to determine which path that the user should follow in his/her life. Subsequently, a display unit of a device may display a list of potential best-matched life paths for the user.

The same and/or similar types of above information and/or processes may be used to answer similar questions/queries, including, but not limited to, “how can I feel more connected with others?”, “how can I better understand my life”, “is it true what others say about me?”, “am I a genius?”, “what good causes should I support?”, etc. However, the differences between these questions may be controlled by the second information 20, which would define each query, and include specific information including, but not limited to, “the user desires to develop particular relationships,” “the user needs an analysis of the user's life,” “the user wants to know how he/she is viewed by others,” “the user would like an interpretation of his/her intellect,” “the user wants to be altruistic in the best way possible,” etc.

As such, the user's generalized question of “what should I do with my life?” is answered by the system 1000, such that the system 1000 outputs a specific answer that is tailored to the user.

### General Complex System Simulation

The system 1000 may ingest information related to a particular complex system, may execute continual simulations on that system, may discover alertable conditions that the user needs to be aware of, and/or, on a continual basis, may make recommendations of actions that the user should take and may provide reasons regarding why the particular actions have been recommended. The system 1000 may maintain a constantly-updated understanding of the state of the complex system and makes this understanding readily available to the user, etc. Also, questions can be posed to the system 1000 related to this understanding, etc.

The user may use an input unit to select a complex system to simulate and/or specify simulation details, such as “simulate the EUR/USD FOREX pair and all aspects of related markets.” The query may then be sent from a device.

### Simulating Economies

The user may desire to receive information regarding a particular economy, or information regarding which is the best economy. As such, the user may use an input unit to input a command to simulate a particular economy or a plurality of economies. Alternatively, the machine 1 may automatically perform a simulation of a particular economy a plurality of economies. Here, the term “command” may be interpreted to be similar to a “query,” as defined above.

When the system 1000 receives the command to perform the simulation of the particular economy, the command may be sent through a network via a communication unit (or alternatively from the machine 1 to a communication unit.

A processor and/or the machine 1 may interpret the command as the second information 20 in order to gather information that may specifically define the command. As such, the second information 20, in this case, may include information including, but not limited to, “a particular economy requires analysis,” “a particular economy needs to be evaluated based on positives and negatives,” “a particular economy should be rated against other economies,” etc.

The server 100 may then access the first information 10 (i.e., information related to the user) either from a storage unit, and/or from external sources. As stated above, alternatively, a device itself may include the first information 10 stored within a storage unit, or may access the first information 10 via a communication unit.

The first information 10 may be subdivided into two types of information, namely information that is generally part of the scenario, situation, and/or context as described above (i.e., general scenario, situation, and/or context information 11), and information regarding the specific current state of the scenario, situation, and/or context (i.e., idiosyncratic scenario, situation, and/or context information 12). Thus, the first information 10 may collectively include, but is not limited to, positive traits of various economies, negative traits of various economies, benefits of various economies as compared to other economies, drawbacks of various economies as compared to other economies, etc., but is not limited to the above information related to the user, i.e., the first information 10, and may include any information available on social media, the Internet, data files, records, etc.

A communication unit may also then access the third information 30 in order to gather information related to the query. As such, a communication unit may access user profiles, social media, external servers, data, websites, or any other type of information related to various economies, and may find information related to various economies that fit into criteria related to the first information 10. A storage unit may store all of the aforementioned information, i.e., the third information 30, for present and future access.

A processor may then process the first information 10 (i.e., the scenario, situation, and/or context information) together with the third information 30 (i.e., the domain information) in the context of the second information 20 (i.e., information defining the query), in order to determine which economy is the best.

Specifically, a processor may run simulations using the first information 10 (i.e., information related to the user) with respect to various different economies and the inherent differences therebetween, which would be part of the third information 30 (i.e., the domain information), in the context of the second information 20. Each simulation is scored and/or rated, and the best scored and/or rated simulation is interpreted to include the best economy. As such, a display unit may display the best result of the simulation, which will be the best economy.

Also, a display unit may display a portion of the results of the simulation, such as the top 10 simulation results, and create a list of economies in a particular order, such as best to worst economies.

Alternatively, a device may access the above information directly, or may acquire it via a communication unit, and then may process the information using a processor in order to determine the aspects of the simulated economy/economies. Subsequently, a display unit of a device may display a list of economies in a particular order, such as best to worst economies.

The same and/or similar types of above information and/or processes may be used to perform simulations on other things, such as a best investment company, solving various problems, determining what type of medical procedure is best (holistic, Eastern, Western, etc.), figuring out the most balanced political system, etc.

As such, the user's generalized command input into the system 1000 to provide a simulation of a particular economy is performed by the system 1000, such that the system 1000 outputs a specific answer regarding all aspects related to the particular economy.

### Various Other Applications of the System 1000

In addition to the aforementioned queries that may be input into the system 1000, there are an unlimited number of applications that can be applied to the system 1000 to run simulations that can generate answers, solutions, suggestions, results, recommendations, explanations, and other output that are catered specifically to the user, the user's needs/desires/requirements/best interests, and/or scenarios, situations, and/or contexts of interest.

Each of the following applications may optionally include one or more explanations as provided by the third simulation information 2030; the presence or absence of any reference to explanation, justification, etc. is solely for expository purposes and conveys no further meaning.

Such applications that may be performed by the system 1000 may include (but are not limited to) the following: Business progress detector and guide (e.g., in business, it can be difficult to tell if one is making progress, how quickly, and what one could do to improve the situation. The system 1000 would instruct the user on how they are doing and how to do better); Identifying the direction in which the user should be going right now with respect to the user's company, life, relationship, etc.; ROI Simulation (e.g., simulating enough of a company's business, markets, customers, and/or environment to be able to tell what the most impactful projects would be, structure and scope projects, explain why those projects are best, and generate related recommendations. In one embodiment, the user may start with an ROI goal in mind, and the system 1000 will guide the user as to how best to achieve said goal); Brand generator (e.g., generating a proper brand for a company using all available best practices); Business messaging and brand story generator (e.g. the system 1000 would identify the messaging effects required for the business to meet its goals, generate appropriate messaging content capable of achieving those effects, explain the means by which those effects are achieved, and generate brand elements based on the foregoing, including without limitation brand content, archetypes, marketing ‘tribes’, concepts, and ideas); Automatic charity donation generator (e.g., given a set of charities, the system 1000 identifies the most impactful ones and how they impact people, and automatically distributes funds from a user's account so that the maximum amount of good is done, based also on the user's values/beliefs/mores/etc. This enables a ‘set it and forget it’ mode of donation likely to maximize positive outcomes); Charity theory of change evaluator (e.g., is the theory that a charity is putting forth actually a good one? Is it likely to work? What would better theories be? Thus, distributing charity across society, and explaining and optimizing theories of change in order to maximize impact); Job Distribution (e.g., how to, as equitably as possible, ensure that everyone has access to employment opportunities based on what they and society need. The system 1000 could discover which jobs are available, determine who is best suited for each job, determine allocations based on individual and broader needs, and match people with jobs while taking relevant criteria and constraints into account); Corporate Social Responsibility Participation Guide (e.g., how should your business be participating in CSR activities? What fits your company the best and will make the most impact?); Simulation-driven governance (e.g., the system 1000 supports policymakers by identifying and simulating various policies in order to maximize governance outcomes); General Situational Awareness and Alerting (e.g. the system 1000 ingests information related to a particular complex system, runs continual simulations on that system, discovers alertable conditions that the user needs to be aware of, and/or, on a continual basis, makes recommendations of actions that the user should take and why. The system 1000 maintains a constantly-updated understanding of the state of the complex system and makes this understanding available to the user); Smart City (e.g., an autonomous ‘brain’ that observes, finds problems in, and makes recommendations for how to optimize and successfully govern cities); Scientific theory generator, validator, and/or grant validator (e.g., in science, theory development can be exceptionally difficult and time-consuming. The system 1000 can help generate and validate theories by understanding problems, suggesting and justifying causal pathways for examination, matching evidence to claims, semantically checking theories by understanding all points of view in light of available evidence, assisting in proving/disproving theories. The same functionality can be employed in support of grant applications, including without limitation assisting granting bodies in determining the likely impact of proposed research, setting research goals, and determining risk factors and resource allocation based on deep examination of all relevant factors and influences); Mental health detector and automated therapist (e.g., the system 1000 objectively interacts with (or supports interaction with) the user in order to determine the user's state of mental health, identifies diagnoses and/or areas of concern, may recommend potential therapeutic paths, and/or indicates metrics and milestones for success and/or indicators of continuing concern—e.g. the first simulation information 2010, the second simulation information 2020, and/or the third simulation information 2030); Automated wellness coach (e.g., understands user, simulates the potential states that user could reach, makes such states available to user, provides explanations and metrics (e.g., the first simulation information 2010, the second simulation information 2020, and/or the third simulation information 2030) and/or may guide user on how to get there. User is able to see their potential, their path, and/or the reasons why what they are doing is likely to work, in real time, thereby, without limitation, increasing motivation, effort likely to be expended, and likelihood of success); How to navigate procurement processes (e.g., government procurements and requests for proposals, including bid preparation, require significant knowledge about organizations, what they do, how they think/see the world, and/or what they actually need, etc. The system 1000 can simulate the customer's context and the foregoing (also in context) and recommend, without limitation, talking and deal points, generally guide the user in preparing a bid that is likely to succeed, and explain why the foregoing is correct and how to know if changes should be made in future (e.g., the first simulation information 2010, the second simulation information 2020, and/or the third simulation information 2030); Simulation of impacts of social media, market information, domain knowledge, electronic data gathering, analysis, and retrieval systems data and/or outputs, transactional data, including without limitation rental vacation stays, AI systems, including without limitation automated bots, and other information on complex sociocultural, sociotechnical, and economic systems; Computer-supported programming (i.e., the system 1000 does some of the programming itself); Training (e.g., the system 1000 can support computer-automated and/or computer-supported training and/or capacity building that may know how the student thinks, what they need, where they are in the learning process, how they are doing, why they may not be achieving goals, how to better achieve goals, and can adapt automatically and explain all of the above to others. In addition, the system 1000 may support training that takes place in the context of a particular program or goal—the system 1000 may discover the most relevant content, triage that content, and/or adjust delivery accordingly); Thinking-based process automation (e.g., the automated achievement of complex tasks that previously would not have been automatable because they require significant understanding of complexity and/or intelligence-related skills akin to thinking, including without limitation complex case adjudication, autonomous systems, medical reasoning, automated analysis/conception/recommendation of current or potential products and services in the context of specific markets, market recommendations, loan awarding and/or other risk determination processes, marketing, recommendation, and/or loyalty programs grounded in simulation of how the customer thinks/feels, psychology, what the customer needs/wants, why the customer should buy from a particular company, and/or automation of other processes. The system 1000 may automatically adjust details (such as, without limitation, loyalty point allocations and/or spend thresholds as appropriate) based on customer needs); Getting knowledge to the edge (e.g., identifying information on complex key functions, such as government, law, medicine, etc. that people need to succeed in their lives, matching this information to recipients, and then assisting in the dissemination of said information); Smart life assistant (e.g. the system 1000 employs user knowledge in order to simulate the user's life, identify problems and concerns, in some cases before the user recognizes them, identify membership in selected groups, and/or provide knowledge and recommendations tailor-made to the user's goals and environment); Obtaining connections when and how your life needs them (e.g., the system 1000 may help connect people to those others that will most make a difference in their lives. At social events, including but not limited to conferences and symposia, the system 1000 may simulate the relative impact of various attendees and triage contacts on this basis. Overlap of interests (including but not limited to atypical interests) and/or other personal attributes may be taken into account during simulation. The system 1000 may generate and/or associate a small amount of information with each potential contact in order to facilitate these connections. The system 1000 may facilitate custom badge augmentations (e.g. notating badges with information that helps people find each other), match generation, and/or list generation and/or other mechanisms for efficiently connecting people with one another); “You are not alone” tool (e.g., you feel like you are in circumstances that feel like they are unique to you, but are they really? Shows you that you aren't really alone); Applying standard principles in business and in government (e.g., it can be hard to know how to take international standards and/or best practices and apply these to specific situations you may face (and/or in general) with respect to a company, country, or other group. The system 1000 can simulate all applicable causal influences, identify best practices requiring application, and accurately guide the user in how to apply them); Pricing and societal pricing impact tool (e.g., the system 1000 may guide businesses and governments in how to price and/or segment offerings while taking customer worldviews, needs, psychology, other context, etc. and market, business, and other contextual elements into account. In addition, the system 1000 can identify how the pricing of specific key goods and services affects various societal interests as a whole, and can support related policy and decision making); Automated health support tool (e.g., the system 1000 may perform diagnoses, identify necessary tests, identify causes for concern, and perform other medical tasks, especially in environments where access to physicians is not available); Virtual Reality augmentations (e.g., tools for augmenting and/or making VR applications more intelligent, more aware of context, change, and domain realities, and help them adapt intelligently to changing circumstances via simulation. In this way, their usefulness and capabilities will be greatly enhanced.); Exploring plausible futures (e.g., walking people through what's probably going to happen, how to best deal with it when it does, and providing the understandings necessary for users to make effective decisions and feel at ease with current contexts and scenarios); Accurate negotiation support (e.g., understand your counterpart in a very high level of holistic detail, know how they can be reasonably expected to respond, know how to maximize success); Ground truth and validated knowledge libraries (e.g., take all knowledge, collate, validate, verify it, allow the computer to draw on it in support of system 1000); Generate transparent systems (e.g., systems that you can trust and verify because you can see and understand what they are doing); Deep humanitarian program modeling (e.g., modeling theories of change and what is really going on in humanitarian/gov't programs, enabling users to understand whom they is affecting and how, as well as how they might be improved); Deep software modeling (e.g., the system 1000 can answer questions such as (without limitation): What is a piece of software actually doing? How is it interacting with other software? Do these interactions make sense/seem reasonable? If not, why not, and what should we do about it?); Customer delight platform (e.g., model every single customer interaction touchpoint in a single unified context so you can understand what is occurring and why and make changes/take actions reasonably expected to delight them); Bid distribution (e.g., how to ensure strong participation across the marketplace (including without limitation vendors, socioeconomic statuses, terms and conditions, outreach venues, etc.) when designing procurements); Market demand discovery and advance prediction (e.g., where are economic markets going? How do we get there first? What should we do when we get there?); Ecosystem builder (e.g., groups often seek to build ‘ecosystems’ like Silicon Valley—this may guide them in doing that. Potential sub-functions include, without limitation, identifying causal requirements for ecosystem establishment and/or success, identifying potential barriers, enhancing decision maker understanding, recommending policy actions and issue mitigations, generating marketing and other types of messages reasonably expected to enhance campaign success, generating metrics and measuring tools, highlighting degree of success achieved, and guiding ongoing development); Alternative justice (e.g., how can we best handle lawbreaking without causing further damage to society and/or the individual? Embodiment simulates and takes into account items including, without limitation, causes of crime, individual circumstances, needs of society, needs of the individual, and/or policy implications, enhances understanding of the foregoing, and may recommend paths forward with justifications); Growth hacking (e.g., how can a company best grow faster? Takes into account items including, without limitation, markets, products, customer needs/situations/contexts/psychology, competitive and regulatory landscapes, etc.); Stock Maximizer (e.g., grounded in an understanding of markets, stocks, investing, investor psychology, etc. the system 1000 can ingest stock reports and decide what, if any impact there is on any given portfolio and/or goal set, provide warnings and associated recommendations, and provide recommendations on what to do/change, if anything, together with associated justifications); Automated Subject Matter Expert/manager (e.g., the system 1000 can automatically guide people in achieving important outcomes by gathering information on, generating a deep causal understanding of, and simulating context, needs, and situations); Pull actionable steps from raw news (e.g., the system 1000 can autonomously ingest news, discover what news elements matter relative to user goals, interests, context, needs, and situations, and why, and generate recommendations on what to do about it, The system 1000 can warn people (and provide recommendations and justifications) if negative events are expected and/or action needs to be taken in response); Expert verifier (e.g. in many decision making instances, it is unclear to what extent expert consensus provides an accurate, actionable basis for decision making. The system 1000 may simulate complex situations and expert inputs and then autonomously compare and contrast the two, providing a means for understanding and engaging with identified differences); Automation (e.g., the system 1000 may move work from people into computers, in order to automate the more difficult parts); Full financial situational awareness platform (e.g., the system 1000 may inform a user how to best invest money, when to make portfolio changes, and may use future-predictive analytics); Rewards (including without limitation credit card and airplane rule arbitrage) (e.g., how to maximize the user's specific utility functions via what the credit card makes available to them? For example, if they receive points for using card/provider X for experience Y, and airline Z has benefit A, how can the user maximize its utility functions/benefits from that?); Experience arbitration (e.g., the system 1000 can trade off experiences to inform a user whether the user should stay home and do X, or go out and do Y); Automated bid/research evaluation (e.g., the system 1000 may provide information regarding unbiased granting of bids); Auto redaction (e.g., the system 1000 may ingest classified or potentially classified information, simulate the effects of each element of that information in context, determine the combined and singular effects of various elements, recommend elements for release and redaction, and perform those redactions. In this, the system 1000 draws on a detailed understanding of what the classification authority is intending to protect and can determine the combined effect (and seriousness of said effects) with respect to various pieces of information); Auto pollution monitors (e.g., the system 1000 may watch for pollution events and suggest remedies in real-time); Configuring and reorganizing complex systems (e.g., when trying to come up with parameters for complex systems, a lot of thinking can be required, which can be performed by the system 1000 to suggest what those parameters should be based on a simulation of the entire system, the uses to which the system will be put, user goals, and relevant contexts/situations); Aviation safety guide (e.g., the system 1000 watches all parameters of an aircraft and uses detailed, unbiased knowledge of the aircraft, including without limitation parameters, handbooks, and procedures, etc. as well as human factors knowledge to guide the user, identify and triage emergencies, warn the user if things don't make sense, recommend mitigations and assist in troubleshooting, and otherwise help the user think in real-time, especially in emergencies); Car auto assistant (e.g., the system 1000 provides a ‘brain’ for the user's car that fuses and integrates all relevant information, watches all elements/metrics of the car, looks at what makes sense, may guide the user, notifies the user of unsafe situations, can perform tradeoffs and goal/outcome triage, and can take over in emergencies if needed. This functionality can be integrated with other related and/or pre-existing functionality); Maintenance assistant (e.g. the system 1000 applies relevant domain knowledge to support the proper maintenance of physical and/or virtual systems (including, but not limited to, cars and/or aircraft). The system 1000 is able to ingest maintenance-related and/or other domain knowledge, triage actions and make recommendations (including but not limited to recommended actions, oil/fluid weight selection, etc.); Life assistant (e.g., the system 1000 may know the user, may recommend things that the user needs and/or would like, keeps the user's life on track, reminds the user of important things/events when needed, and keeps the user out of danger); Workout recommendations (e.g., drawing on extensive knowledge, the system 1000 tailors workouts just to the user, and adapts and adjusts to the user, such that the user's health, workout experience, and personal goals are optimized for); Automated data governance (e.g., governments and those with sensitive private data are often worried about how their data will be used. The system 1000 can automatically manage and control data sharing and governance based on an understanding of and simulations of how the data will be used and the ultimate effects on the entity sharing the data and on broader communities of interest. The system 1000 can automatically rescind/adjust permissions based on the fourth simulation information 2040); Deep recommendations (e.g., the system 1000 may make recommendations in every area of life that take the user's personal details into account as well as detailed knowledge of what is available and the context/people/scenarios/social constrains surrounding the user); Relaxation technique guide (e.g., the system 1000 may show the user how best to relax); Credit card processing ‘brain’ (e.g., the system 1000 handles transaction processing, anti-fraud, risk determination, etc. by simulating queries in relevant context. Likely to discover otherwise undiscoverable fraudulent activities by determining whether transactions make sense in user context as opposed to employing statistical correlations. Likely to allow the granting of credit to those who otherwise may not be able to obtain it.); Connecting everyone's ideas (e.g., the system 1000 makes links between multiple peoples' ideas and research so that they can discover that they (and society) would benefit if they worked together. The system 1000 is able to explain the nature of said links, societal benefits, tradeoff against costs, and explain why); Product and service generator (e.g., the system 1000 autonomously generates products and services that would be of interest to various audiences by simulating markets and potential customer contexts, needs, psychology, situations, and scenarios, suggesting how those details could be fashioned into products or services, and explaining the reasoning and benefits expected to occur for customers and service providers/manufacturers); Grievance detection (e.g., based on an understanding of markets, contexts, situations, psychology, etc. the system 1000 is able to detect when social conditions are such that it is reasonable to expect a conflict, grievance, or violent event may be reasonable to expect to occur); Conflict understanding, reduction, resolution, arbitration, and messaging (e.g., the system 1000 provides deep understanding of conflicts and why they are occurring. The system is able to determine the degree to which any particular action is genuinely just or unjust, and it can generate suggestions for how to reduce conflict in a holistically equitable way. In this way, the system 1000 may act as an accurate, neutral third party and/or arbiter. It can also generate messaging capable of assisting in the achievement of just outcomes. In the case of divorce, the system 1000 can help ensure that all sides obtain reasonable outcomes with a minimum of negativity and/or disruption); Marketing Tool (e.g., the system 1000 can demonstrate exactly how and why to market to specific audiences, what to say to them, and why); Data discovery oracle (e.g., the system 1000 can identify and provide information regarding data that may be able to help the user in some way. It can help the user identify the questions and problems to be addressed and how to frame these. It can help the user understand what problems specific data is capable of solving, and proactively seek out data useful for certain problems. It can also guide the user on how data can/should be understood); Smart legal platform (e.g., the system 1000 may recommend contract language, store and/or employ legal knowledge and/or best practices, help ensure that contracts make sense, and can autonomously review contracts in view of extensive legal, business, and other knowledge, suggest remedies in case of conflict, triage risks and cases, triage provisions, deliver metrics for contract compliance, and detect breaches in support of contract enforcement); Bank support (e.g., the system 1000 may allow banks to open large numbers of accounts with minimal risk, effectively market to and support customers, determine profitability of individual customers and risk of individual customers, and/or allow extended lending and support of new business models with personalized risk simulations); Customer simulation (e.g., the system 1000 can simulate customer behavior to enhance account acquisition, origination, customer relationship management, collections, and recovery); Housing educator (e.g., The system 1000 may help home buyers understand and think through the buying experience in depth before they go through it, in addition to helping buyers understand financial and other relevant aspects); Student debt informant and analyzer (e.g., the system 1000 may help people understand the implications of and tradeoffs inherent in student debt and/or simulate future impact); Marketing and crowded market solutions (e.g., The system 1000 may allow people to know/like/want what a user has to offer, may identify who will be the buyers, may help find new prospects, may help with client connections, etc.); Knowledge manager (e.g., the system 1000 may collect reusable holistic knowledge, convert text and data to knowledge, and build software that thinks based on that knowledge); Decision suggestion tool (e.g., the system 1000 may help a user discover what to do, help make the decision, then help execute on that decision); Empathy simulator (e.g., the system 1000 may perform simulations in order to help users understand others' perspectives and may simulate others' human experiences); Customer value guide (e.g., the system 1000 may perform simulations in order to guide companies on how best to understand and/or create value for their customers. The output of such simulations may include, but is not limited to, how value should be defined in the user's industry, what affects value creation, customer perception of value, how value should be measured, metrics for measuring value, how value-related problems can be fixed, the intersection of customer value with company branding and human values, the efficiency and effectiveness of an entity's efforts to create value); Governance support (e.g., the system 1000 can simulate complex policy environments in order to show how to maximize voter turnout, how to solve financial issues, social problems, etc.); Message forwarding (e.g., the system 1000 may forward, analyze, interpret, and receive messages from any other messaging platform); Customer understanding-driven analytics (e.g., the system 1000 may provide information related to fixing customer problems and the reasons why those fixes are correct by simulating customers based on how the user's company and offerings interact with the customer's goals/needs/context/situation); Work Automation (e.g., the system 1000 may discover keywords, plan blog post topics, write optimize, personalize, and automate content, test landing pages, schedule social shares, review analytics, and/or define content strategies); Review Maximizer (e.g., the system 1000 may provide information that results in improving the likelihood that a customer will leave a review, the quality of that review, and/or the positivity of that review. The system 1000 may take into account the following, without limitation: information on what makes people likely to review products and services, information necessary for the system to discover key elements of the customer experience, and the channels by which companies interacts with customers); Message improver (e.g., the system 1000 may take a message and enhance the likelihood of uptake without changing core meaning) Antiviolence (e.g., the system 1000 may simulate how best to induce people to avoid violence and solve issues through peaceful means); Bias removal (e.g., the system 1000 may identify and remove bias from systems that attempt to discover where crimes are expected to occur); Systemic bias identifier and remover (e.g., the system 1000 may simulate complex social, business, and/or societal systems in order to discover sources and nature of biases within those systems, present solutions for bias eradication in context, and/or provide metrics for discovering future bias); Organizational Insight (e.g., the system 1000 may show how a user's organization really functions, how work actually gets done, and may generate a user-readable representation of how work is done); Personal Productivity Tool (e.g., the system 1000 may provide a personal assistant to guide the user through what the user needs, an email assistant to read through emails to decipher which emails (and which parts of those emails) are most important, and a prioritizing assistant to prioritize anything the user needs prioritized); Trust generator (e.g., the system 1000 may show people how to generate trust in complex scenarios); Invalid news detector (e.g., the system 1000 can simulate the semantic impact of individual news items in broader context given current knowledge and discover whether or not specific news items make sense in context. When invalid news is detected, the system 1000 can suggest messaging likely to reduce the impact and/or duration of impact of said news items. The system 1000 can determine the relative potential impact and/or importance of individual news items, autonomously conduct triage (discover which items are more impactful/urgent than others), and intelligently handle such news items in accordance with their impact and reach); Automated sales system (e.g., the system 1000 may discover, identify, and/or triage potential customers, propose relevant products and services, propose resonant messages, assist in implementation of sales methodologies, and/or provide general sales guidance); Intelligent bounds detection and administration (e.g., the system 1000 may watch over and/or regulate itself and/or another automated system in order to ensure that said systems may only do things that make sense and/or that they are allowed to do given the current context, environment, and situation, and that these systems are operating (and continue to operate) in an unbiased fashion. The system 1000 can discover and recommend criteria for detecting bias relative to what it is tasked to do); Dynamic advertising tool (e.g., the system 1000 may autonomously create advertisements grounded in simulation of customer worldviews, psychology, needs, contexts, situations, etc. The system 1000 can explain the experiences that its advertisements are designed to create, and justify their positivity and correctness); Deal Maximizer (e.g., the system 1000 may guide the user on how to negotiate the best deal and best results on any sort of negotiation); Innovation facilitation (e.g., the system 1000 may use simulations to discover which innovations will be most useful, applicable, helpful, worthwhile, and/or meaningful in context, explain why, and/or suggest means and/or methods of successfully bringing putting those innovations into practice); Jury guide (e.g., the system 1000 may instruct users on how to appeal to a jury, who to select as jurors, and/or identify any pitfalls that can reasonably be expected to arise); Economic parameter detection and prediction (e.g., the system 1000 may instruct policymakers when to change economic parameters and/or inform interested parties when such changes should be expected to take place (and in what directions, for what reasons, and with what anticipated impacts)); Provably safe systems (e.g., the system 1000 is different from most systems, in that it can be proven that it will only take actions and/or make decisions that make sense, are contextually appropriate, are safe, and are in accordance with applicable standards and limitations with respect to how the system should operate. The system 1000 can explain what it is doing and why. Critically, the system 1000 may know when to safely stop and ask for human guidance if the situation warrants it); Policy development and change tool (e.g., oftentimes, the ultimate effects of proposed policy changes and/or candidate platforms can be difficult to discern. The system 1000 discovers which policies would make the most sense in context, may recommend helpful policy proposals, and may guide decision makers on how to best implement those policies); Persuasion Tool (e.g., the system 1000 may instruct users on how to persuade others on issues of great importance); Work Understanding Generator (e.g., the system 1000 can help businesses and governments deeply understand the value of their employees' work and/or learn how to facilitate the success of that work); Security measure recommendation and impact simulation (e.g., in cases where users seek to secure physical, virtual, and/or cyber systems, the system 1000 can employ simulations to discover vulnerabilities, suggest means for securing those vulnerabilities, and/or indicate the need for and/or potential placement of security measures, and explain why all of the foregoing Is correct in context); Living strategic plan (e.g. the system 1000 may help entities build a constantly-updated strategic plan that takes all relevant influences into account. This plan may be continually updated via automated means, and/or may include real-time warnings and alerts); Productivity maximizer (e.g., the system 1000 is able to identify those goals and tasks capable of making outsized contributions to user outcomes (c.f. Pareto principle)); Options generator (e.g. one of the most difficult parts of decision making is the generation of options. The system 1000 may help generate options, including without limitation those that the user may not have thought of and/or may have rejected, and may also help the user triage and/or understand the implications of various options); Personalized booking (e.g., when booking, the system 1000 may simulate the user in depth in order to recommend booking options and/or identify mismatches and/or potential concerns); Automated real-time pricing adjuster/discounter (e.g., the system 1000 may, in real time, determine that discounts/price changes should be applied to specific goods and/or services. The system 1000 may autonomously discover the need for discounts/pricing changes, determine amounts relative to business policies and risk/reward tradeoffs, and/or implement said changes); In-room personalized concierge (e.g., during a hospitality event, the system 1000 may simulate the user in depth in order to recommend purchases and/or experiences, activities, etc. The system 1000 may automatically change prices in response to simulation outcomes); Deep semantics analysis (the system 1000 may simulate the semantic effects of natural language and/or other processable inputs in context, and then determine one or more of, without limitation, the emotions being expressed, the emotions likely to result from reading the input, the impact of the input, etc. The system 1000 may also categorize the input into various categories defined not by rules or features but by semantics. The system 1000 may perform simulation-driven deep semantic analysis in order to determine semantic similarity); Assumption checker (e.g., it can be difficult to know if certain assumptions hold in particular contexts and/or at particular times. The system 1000 may simulate any potential assumption in context and deliver information sufficient to determine whether or not, and/or how, that assumption should be modified); Simulation-based knowledge generation (e.g., the system 1000 may be able to transform its outputs into new causal knowledge which can then support further system 1000 operations); Real-time helper (e.g., the system 1000 may, in real-time, advise and assist users in achieving their goals, including but not limited to decision making, policymaking, acting, planning, crisis management, etc.); Financial (Venture Capital, banking, investment, Mergers and Acquisitions (M&A)) support (e.g., when contemplating potential financial transactions, it may not always be clear what to buy, when, how much to pay, and why. The system 1000 may assist users in answering all of these questions by simulating the effect of various actions within complex markets, situations, and/or contexts. The system 1000 may generate simulation-driven buy/sell signals and/or other recommendations. The system 1000 may also assist in assessing and financing large projects, facilitate loan syndication, and/or facilitate related risk analysis, mitigation, and/or exposition); Customization at scale (e.g., the system 1000 may be employed to add customization at scale to new and/or existing systems. In this embodiment, the system 1000 simulates individual users and contexts and provides appropriate signals to said systems); Automated customer service (e.g., the system 1000 may simulate and come to understand the customer's situation and context, assist in troubleshooting, generate potential resolutions and metrics, triage issues, and/or bring important situations to management attention); Support for social connection networks (e.g. the system 1000 is able to autonomously facilitate the creation of social connection networks, including but not limited to friends, activity partners, communities, movements, and so on. The system 1000 is able to determine which links, means, and/or activities would be best suited for meeting social needs, creating social support and cohesion, socializing, overcoming barriers and trauma, creating positive emotional experiences, increasing general happiness, psychological health and/or longevity, and supporting social organizing. The system 1000 is able to identify potential recommendations and introduce people to one another in such a way that the value of the connection is clear. The system 1000 may also personalize its connections and recommendations such that communities are built in the most positive way for the specific individuals involved, including but not limited to backgrounds, experiences, and matching between the foregoing); Facilitation of difficult hiring (e.g., hiring for certain fields, including but not limited to cyber, music, medicine, law, etc. can be especially difficult because personal knowledge, experience, thought patterns, and/or other attributes are critically important. Moreover, employers may not know how to evaluate potential employees or what perks, ideas, and/or company attributes will be most of interest to potential employees. The system 1000 may simulate this hiring process and provide answers to all of the foregoing); Regulatory environment simulator (e.g., the system 1000 may simulate the complete regulatory environment within which a company exists, as well as the intersections between a company and that environment. The system 1000 may determine compliance, triage obligations, and provide anticipatory guidance related to risks and/or unmet obligations. The system 1000 may also provide automated tax audit-related guidance and support); Job re-engineering (e.g., over time, job descriptions and task allocations may no longer be optimal for the people and companies they support. The system 1000 may simulate the structure and effects of various jobs within an organization (taking all relevant influences into account), discover areas of suboptimality, and/or present recommendations for improvement); Work re-engineering (e.g. in some ways, today's economy has not yet fully caught up with all of the changes brought on by the shift to individualized employment. The system 1000 may simulate various aspects of traditional vs. individualized employment regimes, analyze extended dependencies, identify opportunities for optimization, and/or make recommendations); Company rejuvenator (e.g., in cases where businesses are in danger of failing and/or are not producing desired returns, the system 1000 may simulate the details, context and/or environment within which the target business is situated, determine best courses of action, and recommend actionable strategy and marketing points); External measure for entrepreneurs (e.g., uncertainty plays a critical role in for any party involved in entrepreneurship. All parties may have difficulty determining progress and problems left to solve. The system 1000 may help simulate the company at issue and relevant environment, apply multiple areas of domain knowledge, and deliver actionable understanding about how much progress the company at issue has made and what future directions it should go); Product enhancer (e.g., it becomes ever more difficult to build truly novel products. The system 1000 may simulate a single product and/or a company's current product portfolio, simulate relevant customer situations and contexts, and provide recommendations for how products may be improved); Mechanism for facilitating updatable software without code change (e.g., generally, changes to software systems require (generally complex, often dangerous) changes to source code. If key systems are built around the system 1000, however, then system behavior may be automatically updated simply by changing the contents of a knowledge base, and code changes are not required. Moreover, the key properties of the system 1000 (e.g. without limitation, safety, provable correctness, etc.) would transfer to the key systems.); Support for organizational expansion (e.g., in cases where organizations want to expand into new countries and/or markets, the path forward can be unclear. The system 1000 may simulate business, jurisdiction-specific, political, practical, cultural, best practices, compliance information, and/or other relevant influences in order to generate recommendations and guide users through expansion); Value chain optimization (e.g., in many value chains, missing information, information discontinuities. and/or information asymmetries, etc. lead to inefficiencies and/or suboptimalities. Re-architecting value chains around system 1000 enables transparent, understandable value chain optimization and the removal of non-optimal aspects, properties and/or components. The system 1000 may also clearly articulate the value of specific optimizations in addition to the mechanism by which these are achieved. The system 1000 may also clearly articulate the value to specific customers of particular components of value chains); Psychotherapy support (e.g. the system 1000 can support and/or implement various psychotherapy methodologies, including but not limited to cognitive behavioral therapy, by simulating the user's thinking, situation, and/or context, applying methodologies as appropriate, generating therapeutic recommendations, and/or generating support notes for therapists); Psychology theory development support (e.g., the system 1000 may support psychologists in developing understandings of the human mind by providing a substrate for theory development, testing, and/or explanation); Norm change support (e.g., the system 100 may help advocates determine what sorts of messages and/or communication tools will best reach and/or resonate with target audiences in support of norm change efforts); Restaurant support tool (e.g. the system 1000 can guide restauranteurs in terms of what restaurant they should start, what menu items they should have, what they should charge, and can simulate the effects of various menu items and/or business elements in context); Cause selector (e.g. assists user in identifying causes they may wish to support based on best fit for the user's background, experiences, viewpoints, and/or context, etc.); Leadership selection (e.g., the system 1000 may help determine who should lead a particular group and/or organization based on simulations of how various individuals would be expected to affect the group and/or organization at hand); Food and drink selection (e.g., the system 1000 may employ extensive knowledge of food and drink options in order to help a user determine the right selection for them); Claim adjudication support (e.g., in the case of claims (insurance, medical, etc.) the system 1000 may simulate each individual case in context in order to determine appropriate responses. The system 1000 may ensure that such responses are accurate, essentially bias-free, and in support of all applicable policy and other practical provisions. The system 1000 would provide auditable proof that claims are being fairly and appropriately adjudicated, would always provide justification for all recommendations, and would accurately be able to stay within its approved risk tolerances and levels of autonomy); Professional recommender (e.g. the system 1000 may recommend professionals based on simulations of professionals' capabilities, contexts, situations, and/or personal attributes juxtaposed against the simulated needs, wants, contexts, situations, and/or personal attributes of the user); Environmental action recommender (e.g. the system 1000 may assist the user in determining environmental actions they may want to take in order to create desired change and maximize the positive use of available resources); Impact simulator (e.g. the system 1000 may simulate the impressions left by the sum total of interactions between multiple parties, notify the user when changes are likely required, and guide the user towards a deeper understanding of those impressions in context); Signaling support (e.g. in certain circumstances, users may need to communicate with and/or convey intentions, beliefs, and/or attitudes to others via indirect signals. the system 1000 may guide users towards effective signals that are likely to convey desired meanings while avoiding unwanted consequences); Product and service decoder (e.g., the system 1000 can help users understand why people are buying, what they think they are buying, what products and services are actually providing, how we know, and/or how they may be able to be improved); Competition assistant (e.g., the system 1000 may help users determine how to best handle business competition); Anti-bullying (e.g. the system 1000 may help users determine the causes and/or origins of bullying and other negative behaviors, develop action plans, justify those action plans, and/or explain the mechanism behind said plans); Control system (e.g. the system 1000 may act as or support a control system) and/or Cultural shifting (e.g., the system 1000 may show how to create positive change in cultures and other complex environments).

Additionally, the system 1000 may be able to take data that is grounded in one specific schema, worldview, context, and/or perspective, extract the pure semantics of that data, simulate how those semantic components would be viewed from another worldview, context, and/or perspective, and then automatically translate the original data into one or more new schemata, worldviews, contexts, and/or perspectives.

This capability allows the system 1000 to fuse, repurpose, and/or simulate an unlimited range of information, regardless of the original format, schema, or original purpose of the information.

In essence, the system 1000 may be able to understand any sort of complex knowledge, think about it, perform tasks, answer questions, and/or explain why and what matters.

### Summation of the System 1000

In some embodiments, the system 1000 may be designed to receive any query input by the user or by the machine 1 running the automated process into the system 1000, and to perform simulations using the various information (i.e., the first information 10, the second information 20, and the third information 30) in order to determine rating/score results of the simulations, so that the best rated/scored simulations includes answers to the queries that are tailored to specific scenarios, situations, contexts, and/or users' needs, regardless of the user's conscious or subconscious desires. As a result, in addition to the queries outlined above, various broad and generalized queries may be answered by the system 1000, including, but not limited to, “what could go wrong with a particular decision?”, “how do I resolve a particular conflict?”, “how do I make a person feel a particular way,” “how do I understand and/or fix a culture?”, “what do I need to know before entering a particular situation or paradigm?”, “how should I respond to a particular action that someone else has taken?”, “how do I get someone else to understand specific information?”, etc. Since all the information that exists in the world is available to answer these queries, the system 1000 is able to output an answer that is best tailored to the user, scenario, situation, and/or context.

In some embodiments, the system and method provides nuanced artificial intelligence reasoning, decision-making, and recommendations that allows for extraction and/or use of many types of knowledge, including but not limited to implicit, explicit, real-world, cultural, psychological, practical, processual, and/or physical knowledge, in any given domain, enabling solutions to problems unlike those previously anticipated by the system and allowing for minimal pre-cognizing of problem domains. The technology described herein provides for detailed reasoning. It can represent many different forms of knowledge using the same knowledge representation, greatly facilitating the fusion of information from different domains.

According to some embodiments of the present disclosed system and method, a system provides nuanced artificial intelligence, reasoning, decision making and recommendations includes a computer processor; a nonvolatile computer-readable memory; and a data receiving interface, wherein the non-volatile computer-readable memory is configured with computer instructions configured to: receive input data via said data receiving interface; transform input data into a set of concept energy tuples, wherein each concept energy tuple describes how much energy should be placed in a particular concept node; generate and/or select one or more knowledge models; propagate one or more concept energy tuples selected from said set of concept energy tuples throughout said one more knowledge models; and generate output data via processing said propagated concept energy tuples through a reasoning substrate.

According to some embodiments, the non-volatile computer readable memory is further configured to execute post-processing steps on said output data via a goal inference process, generating new final output data.

According to some embodiments, the goal inference process includes identifying concepts, ideas, and keywords potentially indicative of user interests, processing knowledge substrates in order to determine what goals the user may be attempting to achieve as well as other concepts that are semantically related to user interests and/or goals.

According to one exemplary embodiment, energy placed into the concepts representing each user interest is reverse propagated in a reverse direction to discover goals consistent with a user's interests.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium can be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosed system and method as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof can be implemented as parts of a monolithic software structure, as standalone software modules, or as modules that employ external routines, code, services, and so forth, or any combination of these. All such implementations are within the scope of the present disclosed system and method.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions can include computer executable code. A variety of languages for expressing computer program instructions are possible, including without limitation C, C++, Java, JavaScript, Python, assembly language, LISP, and so on. Such languages can include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads can be processed more or less simultaneously to enhance utilization of the processor and to facilitate substantially simultaneous functions. By way of implementation, any and all methods, program codes, program instructions, and the like described herein can be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems can also be used with programs in accordance with the teachings herein, or it can prove convenient to construct more specialized apparatus to perform the required method steps. The required structure for a variety of these systems will be apparent to those of skill in the art, along with equivalent variations. In addition, embodiments of the disclosed system and method are not described with reference to any particular programming language. It is appreciated that a variety of programming languages can be used to implement the present teachings as described herein, and any references to specific languages are provided for disclosure of enablement and best mode of embodiments of the disclosed system and method. Embodiments of the disclosed system and method are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems can be presented in one or more languages and the language can be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosed system and method will become apparent to those skilled in the art from this detailed description. The disclosed system 1000 and method is capable of myriad modifications in various obvious aspects, all without departing from the spirit and scope of the present disclosed system and method. Accordingly, the drawings and descriptions are to be regarded as illustrative in nature and not restrictive.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

Any examples given are not intended to be, and may not be interpreted as, exhaustive in any respect.

No inferences are intended nor may be drawn from the presence, absence, configuration, use, non-use, and/or any other aspect of the drawings.

No inferences are intended nor may be drawn from the designation of the instant application and/or any other application as a continuation vs. continuation-in-part.

1. A system having a program executed thereon to answer a query, the system comprising:
a server to at least one of store and access first information, to at least one of store and access second information, and to at least one of store and access third information; and
a device, comprising:
an input unit to allow the query to be input into the device,
a communication unit to communicate with the server to access the first information, the second information, and the third information,
a processor to output an answer to the query based on the first information and the third information with regard to a context of the second information, and
a display unit to display the answer to the query.

2. The system of claim 1, wherein:
the first information comprises information related to at least one of the user, a scenario, a situation, and a context;
the second information comprises information defining the query; and
the third information comprises domain information related to the query.

3. The system of claim 2, wherein the information related to the user comprises at least one of general information about the user, idiosyncratic information about the user, information that is surmised about the user, information that is deduced about the user, information that is associated with the user, information that is tangentially related to the user, information regarding a personality of the user, information about the user's medical history, information about the user's preferences, information regarding the user's work history, and information about the user's personal history.

4. The system of claim 2, wherein the information related to the scenario, situation, and/or context may include at least one of general information about the scenario, situation, and/or context, idiosyncratic information about the scenario, situation, and/or context, information that is surmised about the scenario, situation, and/or context, information that is deduced about the scenario, situation, and/or context, information that is associated with the scenario, situation, and/or context, information that is tangentially related to the scenario, situation, and/or context, information that is directly related to the scenario, situation, and/or context, information regarding the history of the scenario, situation, and/or context, information about general preferences, information regarding the causal components of, contents of, participants in, and/or influences on the scenario, situation, and/or context, and information that explains and/or describes the scenario, situation, and/or context.

5. The system of claim 2, wherein the processor outputs the answer to the query by executing at least one simulation including the first information and the third information with regard to the context of the second information.

6. The system of claim 5, wherein the answer to the query is based on a best score or rank assigned to one of the at least one simulation, as a result of the at least one simulation simulating various combinations of the first information, the second information, and the third simulation.

7. The system of claim 6, wherein the combination of the first information, the second information, and the third simulation that produces the best scored or ranked simulation comprises the answer to the query that is best tailored to the user.

8. The system of claim 5, wherein the information defining the query comprises information that parses or interprets the query to allow the processor to understand and utilize the query during the at least one simulation.

9. The system of claim 5, wherein the at least one simulation is executed based on the first information, the second information, and the third information with regard to a context of at least one of first simulation information, second simulation information, third simulation information, and further simulation information.

10. The system of claim 9, wherein:
the first simulation information is related to at least one of metrics, indicators, Key Performance Indicators (KPIs), and other mechanisms to allow the user to determine how to view or measure the situation, context, or problem giving rise to the query;
the second simulation information is related to at least one of metrics, indicators, and other mechanisms that may allow the user to determine whether or not the situation, context, or problem giving rise to the query is proceeding in a manner envisioned by at least one of the user and the system;
the third simulation information is related to at least one of explanations, justifications, and other expository content intended to allow the user to understand the reasons for or justifications for the generated output; and
the fourth simulation information is related to various safety rules or guidelines that are inherently required by the system.

11. The system of claim 2, wherein the domain information related to the query comprises at least one of information that is semantically relatable to the query and information that has a tangential relationship with the query.

12. The system of claim 1, wherein the device receives data that is grounded in at least one specific schema, worldview, context, and perspective, extracts pure semantics of the data, simulates how components of the pure semantics of the data would be viewed from at least one other worldview, context, and perspective, and then automatically translates the received data into at least one new schemata, worldview, context, and perspective.

13. A device having a program executed thereon to provide an answer to a query, the device comprising:
an input unit to allow the query to be input into the device;
a communication unit to communicate with outside sources of information to access a plurality of information;
a processor to use the plurality of information to execute a plurality of simulations and to rank the plurality of simulations in order to determine which one of the plurality of simulations has a best rank; and
a display unit to output the answer to the query as the information that produced the best ranked simulation.

14. The device of claim 13, wherein the plurality of information comprises:
first information comprises including information related to at least one of the user, a scenario, a situation, and a context;
second information including information defining the query; and
third information including domain information related to the query.

15. The device of claim 14, wherein the plurality of simulations are executed based on the first information and the third information with regard to a context of the second information.

16. The device of claim 13, wherein the query is input by at least one of a user and an automatic process.

17. A method of answering generalized queries within a system including a device having a program executed thereon and a server communicating with the device, the method comprising:
receiving an input of a query in at least one of an input unit of the device and another input unit of the server;
retrieving from at least one of the server and the Internet, first information related to a user, second information defining the query, and third information related to the query;
executing a plurality of simulations within at least one of a processor of the device and another processor of the server, the plurality of simulations being executed by utilizing various combinations of the first information related to a user, the second information defining the query, and the third information related to the query;
ranking the plurality of executed simulations based on a most favorable outcome for the user;
outputting the best ranked simulation; and
displaying information that output the best ranked simulation as an answer to the query.

18. A system having a program executed thereon to answer a query, the system comprising:
a server to at least one of store and access first information, to at least one of store and access second information, and to at least one of store and access third information;
a machine to automatically provide an input of the query; and
a device, comprising:
a communication unit to receive the input query from the machine and to communicate with the server to access the first information, the second information, and the third information,
a processor to output an answer to the query based on the first information and the third information with regard to a context of the second information, and
a display unit to display the answer to the query.

19. A system having a program executed thereon to answer a query, the system comprising:
a server to at least one of store and access first information, to at least one of store and access second information, and to at least one of store and access third information;
a machine to automatically provide an input of at least one query; and
a device, comprising:
a first communication unit to receive the at least one query from the machine and to communicate with the server to access the first information, the second information, and the third information,
a processor to generate at least one answer to the at least one query based on the first information and the third information with regard to a context of the second information, and
a second communication unit to communicate at least one aspect of at least one answer to the at least one query.

20. The system of claim 19, wherein at least one aspect of at least one item selected from the group of the first communication unit, the second communication unit, the at least one answer, the information processed by the processor, and the at least one query relates to at least one item selected from the group of at least one network, at least one server, at least one person, at least one business, at least one facilitator, at least one knowledge provider, at least one organization, at least one customer, at least one client, and at least one entity.

21. The system of claim 19, wherein at least one aspect of the at least one answer is generated relative to at least one item selected from the group of knowledge, information, domain knowledge, and domain information.

22. The system of claim 21, wherein at least one aspect of the at least one item selected from the group of knowledge, information, domain knowledge, and domain information relates to at least one aspect of at least one item selected from the group of at least one person, at least one business, at least one facilitator, at least one knowledge provider, at least one organization, at least one customer, at least one client, and at least one entity.

23. The system of claim 19, wherein at least one aspect of the information processed by the processor relates to best practices.

24. The system of claim 19, further comprising the presence of at least one aspect of at least one reward
